(19) United States
(12) Patent Application Publication
(10) Pub. No.: US 2024/0339280 A1
(43) Pub. Date: Oct. 10, 2024

(54) CATHODE BASED ON THE MATERIAL C12A7: E (ELECTRIDE) FOR THERMIONIC ELECTRON EMISSION AND METHOD FOR USING SAME

(71) Applicant: Advanced Thermal Devices S.L., Madrid (ES)

(72) Inventor: Jose Fabian Plaza Fernandez, Madrid (ES)

(73) Assignee: Advanced Thermal Devices S.L., Madrid (ES)

(21) Appl. No.: 18/293,424

(22) PCT Filed: Jul. 5, 2022
(86) PCT No.: PCT/ES2022/070431

§ 371 Date: Jan. 30, 2024

(30) Foreign Application Priority Data
Aug. 10, 2021 (ES) P202130778

(51) Int. Cl. H01J 1/14; H01J 1/304

(52) U.S. Cl. CPC H01J 1/14; H01J 1/304

(57) ABSTRACT

Cathode based on the C12A7:e-“electride” material for thermionic emission of electrons and procedure for its use. The specific ways and conditions for using the material C12A7: e (“electride”) as an electrode and more specifically as a cathode and more specifically as a cathode electron emitter in all applications likely to use the property, as electron emitting cathodes for ionic thrusters and neutralizers in aerospace applications, cathodes and electrodes in general that interact with ions, whether in a gaseous state (plasma) or liquid (electrolysis, water treatment, Hydrogen generation) or combination of both liquid and gaseous (Hydrogen fuel cell) as well as active (polarized) catalysts for the synthesis and decomposition of certain compounds (specifically ammonia). Focusing on maximizing the use of the material properties as a cathode and on its operation stability under different conditions, through specific pulsed polarization techniques that adapt precisely to the nature of the material.

### CROSS REFERENCE TO RELATED APPLICATION

This application is a National Stage Entry of PCT/ES2022/070431 filed Jul. 5, 2022, under the International Convention and claiming priority over Spain Patent Application No. P202130778 filed Aug. 10, 2021.

### DESCRIPTION

Cathode based on the C12A7:e-“electride” material for thermionic emission of electrons, and procedure for its use

### TECHNICAL FIELD

The present invention refers to the specific ways of use of the material C12A7:e-(“electride”) as an electrode and more specifically as a cathode and more specifically as an electron emitter in all fields likely to use its properties, that is, when an electrode has to interact with ions or the electrode has to interact with other materials implying a not strictly ohmic contact but as a metal-semiconductor union or by direct electron emission (electron-emitting cathode).

The fields of application will be those likely to use said electrode-metal interaction, or electrode-ions or electrode directly in vacuum as electron emitter, such as the aerospace field systems (electron-emitting cathodes, both in vacuum and with plasma, for neutralizers and ionic thrusters) that involve the interaction of the electrode made with the material with ions, whether in a gaseous state (plasma) or liquid state (water electrolysis for hydrogen generation and treatment of water) or as a combination of both liquid and gas (fuel cells of Hydrogen) or as well as its use as an active catalyst (polarized). The invention focuses in the maximum use of the properties of the material C12A7:e-“electride” as cathode and in its stable operation under different conditions, using specific techniques of pulsed polarization, arrangement of auxiliary electrodes, selection of suitable materials and modes of operation.

### BACKGROUND OF THE INVENTION

The analysis of the state of the art of the inventions has been carried out on a total of over 800 different patents. All those patents mentioning the use of C12A7 material (297 results) or mayenite material (257 results) have been analyzed, resulting in some of them being the same but with different identification.

In addition to these search criteria, the study has been extended to all those patents that mention the use of electride-type compounds to collect those inventions that could be related with reference to the use of this type of compounds in a generic way. This additional search resulted in 338 results. Eliminating the results that appear duplicated in the different searches we are left with a set of 848 different patents, as a global result, spanning since June 1903 (U.S. Pat. No. 916,575A) until December 2020 (CN112592085A). The first 31 patents, prior to the discovery of Mayenite in 1964 in Mayen (Germany) have been analyzed for mentioning the use of compounds of the type “electride” in its invention. Some of them refer to components of vacuum tubes and valves or other types of apparatus and discharge devices (U.S. Pat. No. 1,479,778A, CA310089A, U.S. Pat. No. 2,351,305A, CA495721A, U.S. Pat. No. 2,735,037A), but in none of them have found claims about the use of the mechanisms and techniques of capacitive coupling to favor thermionic emission.

Since its discovery in 1964, the mineral mayenite and its synthesized ceramic material C12A7 were massively used in the cement industry, but it was not until early 2000s with the first research in Japan and especially with those of Professor Hideo Hosono's team when they managed to transform ceramics C12A7 in the “electride” compound C12A7:e- by replacing oxygen ions with electrons.

The appearance of the first patent relating to an “electride” compound derived from ceramic C12A7 takes place in 2001 in Japan (JP2001321251A) and was later extended and published as EP1445237A1; EP1445237A4; EP1445237B1; JP2003128415A; JP3560580B2; U.S. Pat. No. 20,050,53546A1; U.S. Pat. No. 7,235,225B2; and finally published as WO03033406A1 dated 2003 Apr. 24. It did not yet talk about the substitution of oxygen ions by electrons, but by OH ions, although it was already indicated that it could have scopes of application as a catalyst, as an antibacterial agent, as a material ion conductor, or as an electrode for solid fuel cells. However, it does not describe any specific apparatus or device, nor the mode of operation of this new compound for any of these applications.

Out of the 248 patents resulting from the search that appear from 1964 to the mentioned JP2001321251A dated 2001 Oct. 18, there are 51 of them that are relative to the C12A7 or mayenite as a component of cements, a few are to the material such as general catalyst (DE10136478A1; EP1114675A2; EP1114676A2;) and regenerable catalyst (EP1353748A2; EP1353748B1), and a few others as a component in the synthesis and manufacturing of other types of materials and compounds other than “electride” (CN1202275C; CN1386144A; JP2001157837A; KR100333669B1; JP3699756B2).

But the vast majority of those 248 patents refer to “electrides” in a general sense, either deposited or directly used as electrodes for different applications, of which only 41 are after 1993 (U.S. Pat. No. 6,350,994B1; CN1395106A; CN1268230C; CN1438840A; CN1327859A; U.S. Pat. No. 20,010,45565A1; U.S. Pat. No. 7,339,317B2; ITSV20000019A1; CN1316782A; U.S. Pat. No. 20,010,17679A1; JP2001144107A; WO0079546A1; WO0079546A1; CN1139115C; JPH11283441A; JPH11281476A; JPH11281476A; U.S. Pat. No. 5,981,866A; JPH11209033A; JP4011692B2; JPH11102661A; U.S. Pat. No. 5,874,039A; JPH1136099A; BG101700A; U.S. Pat. No. 6,361,822B1; U.S. Pat. No. 5,994,638A; JPH10178141A; BG103488A; EP0843410A2; U.S. Pat. No. 6,103,298A; CA2287006A1; JPH09134686A; JPH09167618A; JPH09180704A; JP3512295B2; JPH09122246A; JPH08207290A; U.S. Pat. No. 5,618,451A; JP2001315593A; JPH087658A; CA2183074A1). None of the patents referring to “electrides” published between 1964 and 2001 mentions the use of specific cathode polarization mechanisms and much less any capacitive coupling mechanism for thermionic emission of electrons.

From the first Japanese patent on the transformation of C12A7 ceramic into “electride” (JP2001321251A) dated 2001 Oct. 18 and until the end of 2020 another 568 patents are found, of which, due to the fact that the C12A7 ceramic material has been used massively as a component of cement, it turns out that a high percentage of the patents refer to this use of the material C12A7 or mayenite, and not only in the oldest patents starting with the Lafarge Cements patent (U.S. Pat. No. 3,705,815A) in 1970, but also in very recent patents, especially by companies, research centers and universities from Asian countries such as Korea or China. Thus, for example, 20 of the 27 patents analyzed in 2020 refer to this type of cement compounds, while 5 include inventions related to the use of C12A7 “electride” material, or its compounds with Ru (Ruthenium) and other metals, in applications as a catalyst. Only 2 patents from 2020 that mention the material C12A7 (CN111774276A and CN112201555A) describe inventions of thermionic emission.

On the other hand, of those 568 patents after JP2001321251A there is also a large number of them that refer exclusively to the methods and processes of synthesis of the ceramic and its transformation into “electride” C12A7:e-, without going into a description of devices or appliances for any specific application (for example CN109208079A).

Focusing on the rest of the patents not referring to the manufacture of cements and their applications, and those referring to synthesis and growth processes of thin layers of “electride”, the rest can be grouped into three main sections:

Devices and equipment for residential or industrial use such as discharge lamps, microwave ovens, photovoltaic solar cells, imaging and light emission devices, decontamination of water and soil, lithium extraction, etc.

This first group includes a series of inventions related to devices and apparatus for different applications and uses:
In discharge lamps (JP2014006961A; JP2013104898A; JP2013045528A; TW201232599A; WO2011024821A1; WO2010074092A1; EP2302662A1; JPH11102661A) In microwave ovens (JP2015216006A);
In photovoltaic cells (JP2020072085A; KR101920127B1; JP2010016104A);
For imaging and light emission (CN109880615A; U.S. Pat. No. 20,151,37103A1; JP2010016104A; EP1887605A2)
As a catalyst in various processes including decontamination of water, soil, and air (U.S. Pat. No. 20,202,82162A1; JP2020138902A; CN109485454A; CN109433199A; CN108855121A; CN108892982A; CN109876866A)
For lithium extraction (CN109019643A)

None of the previous patents are comparable, neither in the architectures used nor in the forms of polarization of the “electride” nor in the applications themselves.

In a second group, devices and apparatus used in electrolysis, synthesis or decomposition of compounds for the generation of green hydrogen or applications of fuel cell.

This second group is, basically, a subset of the previous ones but focused on particular to the use of the material to simplify and reduce the costs of generating hydrogen by electrolysis of water or other compounds such as ammonia (CN112473680A; CN111804298A; CN111558377A; CN111558376A; CN111167443A; JP2021025118A; WO2021010167A1; CN111097421A; WO2019156029A1; WO2019003841A1; WO2018110651A1; EP3498372A1; JP2018016500A; JP2016204232A).

In none of the patents analyzed is there any mention of a thin dielectric layer at the surface of the material, nor the distinction between DC and pulsed operation, nor the convenience of one or the other given that not all the variables that affect to the functioning of the material are described, making thus difficult to identify the most efficient operation mode for its use in certain applications.

### Devices and Apparatus for Electric Propulsion.

The third group is a set of applications based on the high ionizing capability of the “electride” and its use in electric propulsion systems both in propulsion and in neutralization, and it is where we can find some inventions and claims using the expression pulsed for some type of operations (U.S. Pat. No. 20,211,00089A; U.S. Pat. No. 10,269,526B2).

There are no claims in these patents that conflict with the claims of the present patent. They make no reference to the dielectric layer or to the need to apply charge coupling techniques to carry out the thermionic extraction of electrons through that thin non-conductive layer. They also do not indicate the polarization mechanism of the cathode, its amplitude, its sign with respect to the “keeper”, nor its frequency. In the present invention the so-called “keeper” is used as a reference of the charge coupling and not as an electrode with the same function performed by the grids of vacuum tubes for charge extraction or emission modulation. In fact, the current through said electrode in the present invention does not reach 2% (normally less than 1%) of the total emission current even if the anode is at zero volts (ground) or even at negative potential with respect to said grid or “keeper”, which is something not possible to achieve when using any usual configuration such as a grid or “keeper” as in the analyzed patents, where the “keeper” current becomes even greater than the own anode current even when the anode is positively polarized. This is one of the distinctive characteristics of the present invention given that in all studies, articles, patents and references, the “keeper” current is comparable or superior to the anode current, also requiring a positive polarization of the anode. In the present invention, the “keeper” current is less than 1% of the anode current and it can be polarized to zero or even negative with respect to ground. This feature represents losses below 1% since the “keeper” current is not useful from the final application point of view, which is the anode current or electron beam achieved for a certain input power.

Finally, it is important to highlight that the base system of the invention has nothing to do with pulsed plasmas or certain pulsed regimes in ionic neutralizers or thrusters. In all these cases, the pulsed mode refers to the plasma or emission itself, usually low frequency. In the present invention the pulsed operation mode is referred to the cathode and it is not necessarily transferred to the plasma when using the appropriate design. That is, the anode current can be practically direct current (DC) with small ripples and is even possible to switch completely to DC mode. In other words, the pulses are not moving beyond this auxiliary electrode that is part of the cathode.

### SUMMARY OF THE INVENTION

The material C12A7:e- is an “electride”, that is, a crystalline structure where the electrons act as anions (rather than conventional negative ions). The electrons are “confined” between two C12A7 ceramic cells replacing oxygen ions. In this case, the original C12A7 is a non-conductive ceramic material while the C12A7:e-“electride” is equivalent to an n-type semiconductor with a “doping” or concentration of electrons available for conduction between 10²⁰ and 1021 cm⁻³, reaching “metallic conduction” nature when reaching the maximum possible concentration allowed by the nature of the cells of the material, which is 2.3*1021 cm⁻³. Normally, “electrides” are not stable at ambient conditions and require special temperature conditions and generally non-oxidizing atmosphere. However, the material C12A7:e- is stable in any atmosphere at temperatures up to 150° C., and in vacuum, or non-oxidizing atmospheres, up to 1000° C. Therefore, it is an ideal material for profiting of the main characteristic of this kind of electride materials: their low work function (2.4 eV) and, therefore, the thermionic emission of electrons at relatively low temperatures (from 650° C. to 950° C.) compared to the commonly used materials (LaB₆, Thoriated W, etc, which work above 1200° C.). Therefore, it is a suitable material for manufacturing of electron-emitting cathodes that are used in a multitude of applications. However, the stability of the material is the root cause of its own problems in operation that have made it unsuitable until now. This is because said stability is due to the creation of a dielectric layer on the surface of the material whatever the procedure of synthesis. The above, in turn, is due to the impossibility of finishing the crystalline structure with confined electrons (“doped” cells) at its interface with outside without degradation, as happens with all elements and materials with a low work function (alkaline and alkaline-earth) whose stability is impossible in oxidizing atmospheres. Somehow, the material, instead of degrading entirely, is passivated with a layer dielectric of the same non-conductive C12A7 ceramic structure and even with other phases non-conductive ceramics (CA, C3A). This passivation is what keeps the material stable. and it cannot be avoided unless it was kept in a high vacuum since its synthesis, an aspect that makes it impossible to manufacture any device.

The effects of the dielectric layer of the material are basically:

High impedance on the surface that causes low current densities of emission even when the “electride” is of very good quality (high concentration of electrons) as well as poor quality ohmic contacts with losses and with metal-semiconductor junction effects.

Instabilities in the emission, with the superposition of an infinite number of pulses to the DC signal and, what is worse, random and uncontrolled discharges that deteriorate the emissive surface of the material, cause damage to other systems and auxiliar equipment and end up completely degrading the material in a short time.

Need to operate in the high-temperature range (800-950° C.) to decrease, where possible, the impedance of the dielectric layer (decreasing with temperature as a semiconductor characteristic).

Degradation of the material in the presence of oxidizing ions, even in proportions of less than 1 ppm.

Added to the above are other properties such as the very low thermal conductivity (1.5 W/mK) which, added to the fact of having positive conductivity coefficients with temperature as a semiconductor, causes uncontrolled hot spots that can melt the material. This effect occurs especially when the material is used to manufacture hollow cathodes.

Solution attempts, until now, have focused on trying to improve the conductivity of the dielectric layer based on metal and semiconductor doping and other treatments that, although they manage to increase said conductivity, they also alter the characteristics of the material, especially the most important one to conserve: the low work function that allows for high thermionic emission.

The present invention consists of the design of the appropriate structures and mechanisms to overcome the problem of the dielectric layer without altering the material, reaching standard designs applicable to any device for the emission of electrons in high vacuum, in contact with ions (plasma) and even in contact with other media with ions, such as water in both liquid and vapor phases. The invention achieves:

To increase the emitted current density as if the limitation of the dielectric layer on the surface of the material practically did not exist.

It eliminates instabilities and uncontrolled discharges, which is the most important problem for its reliable use in some environments, especially aerospace. Consequently, the material does not degrade over time.

Allows stable operation at very low temperatures (200° C. to 350° C.) both in vacuum and in plasma (“cold cathode” from start-up)

Eliminates the need for heaters to reach the ideal temperature for each application.

Degradation is prevented in oxidizing environments, allowing the operation with very reactive ions such as iodine (I) which is essential as a very effective propellant in weight/volume ratio for aerospace electric neutralizers and thrusters, and also its use as a cathode for the hydrolysis of water and the interaction with other ionic media, something theoretically impossible with typical “electrides” that degrades immediately in contact with water.

The invention consists of a cathode obtained from the material C12A7:e-“electride” with pulsed polarization mode, with negative voltage with respect to ground, or zero potential reference, or with respect to the anode in case of floating potential.

The emission current is increased by charge coupling with an additional electrode (“keeper” or in some cases anode) specially arranged for this through an additional dielectric layer that defines a medium which avoids direct contact with the “electride” at a very short distance (tens or hundreds of nano meters in the case of integrated manufacturing and tenths of a millimeter when using physical separators) and, the coupling values being fixed independently of the thickness of the natural and unavoidable “electride” dielectric layer.

Meanwhile, the dielectric layer on the surface of the “electride” has a heterogeneous thickness, to which an auxiliary electrode (“keeper” or anode as the case may be) and a pulsed regime between the cathode and said electrode is coupled.

The described procedure for the thermionic emission of electrons from the cathode consists of the cathode being subjected to a heating phase through a series of pulses between the cathode and the auxiliary electrode (“keeper” or anode) as a stabilizing mechanism when starting operation as a cold cathode, and even operating directly as a cold cathode at temperatures between 150° C. and 250° C. in a stable manner maintaining the corresponding pulse regime, so that said heating is produced by the Joule effect of the coupling between the “electride” and the auxiliary electrode. In cases of use of plasma, the heating by Joule effect of the cathode-keeper coupling is combined with the bombardment of the plasma itself.

Coming back to the cathode structure, the dielectric added between the surface of the “electride” and the auxiliary metal electrode is made of a thin layer (tens or hundreds of nano meters) of hafnium oxide (HfO₂) deposited by reactive sputtering or ALD (Atomic Layer Deposition) or PLD (Pulsed Laser Deposition) or any other technique that allows depositing thin-film layers (nanometric) of hafnium oxide in a homogeneous (without gaps that could cause short circuits) and maintaining its dielectric properties. Optionally, and for operation at low temperatures, said dielectric could be made of SiO₂, MgO, Al₂O₃, BN, etc.

Meanwhile, the auxiliary electrode (“keeper” or anode as the case may be) is made by deposition of thin layers of metal (tens or hundreds of nanometers thick) on the previous dielectric by sputtering, evaporation or other applicable techniques.

This electrode can also be made by using thin sheets (between 0.1 and 1 mm) of metal supported on dielectric spacers.

Regarding the metallization of the contact surface of the cathode (rear face in case shaped like a disc or hollow disc, or back face and outer walls in the case of hollow cylinder), this is preferably done with molybdenum (Mo) deposited as thin film (hundreds of nano meters) with sputtering techniques and other techniques for this case, so that massive tunnels are produced between said metallization and the inside of the “electride” saving the dielectric layer. As an option, when working at low temperatures, the metallization could be carried out with Ti, Pt, Pd, W, Ta and Cr and other metals that are diamagnetic or paramagnetic with very low magnetic susceptibility.

Regarding the metallization of the auxiliary electrode, this is done with platinum (Pt) or palladium (Pd) in cases where a great difference in work functions is required between said electrode and the cathode (for example electrolyzers and fuel cells) or also with Ir, IrO₂, Ti+IrO₂, Ti+RuO₂, while molybdenum (Mo) and titanium (Ti) are used for intermediate cases regarding work function of the anode and hafnium (Hf) and tantalum (Ta) for the lowest possible work function on said electrode, deposited as a thin film (hundreds of nano meters) with sputtering techniques and other techniques for this case, or alternatively sheets of 0.1 to 1 mm thick of said metals can be used in the case of using dielectric thin physical separators instead of thin films. For special cases when working at low temperatures, the metallization is carried out with W, Ta and Cr and other metals that are preferably diamagnetic or paramagnetic with very low magnetic susceptibility.

In accordance with another of the characteristics of the invention, it has been foreseen that the cathodes are used as free electron generators in high vacuum (thermionic electron beam emission) in a temperature range between 800° C. and 950°, where heating is performed through the pulsed polarization mode between the cathode and the auxiliary electrode (“keeper”) without heater (“heaterless”).

They could also work in a temperature range between 200° C. and 350° C., causing thermionic emission due to the Schottky effect rather than temperature (without heater or “heaterless”) thanks to the coupling of the cathode with the auxiliary electrode and the pulsed polarization mode.

Another option for the cathodes are to be used as free electron generators in a medium with plasma or to generate said plasma through the injection of a noble gas (He, Ne, Ar, Kp, Xe) or with hydrogen and other gases (N₂, Iodine and sublimed metals), where the shape of said cathodes may be a disc, between 4 and 50.8 mm in diameter and 1 to 2 mm thick, a hollow disc the same as the previous one but with gas inlet right in the center of the hollow disc, or a hollow cylinder (usually named “hollow cathode”).

At the same time, the cathodes can be used in high vacuum for the manufacturing of ion beam neutralizers used in aerospace electric thrusters, or electron guns for high vacuum in general (microscopy, “electron etching”, etc.).

Another additional application of the cathodes of the invention is their use in high vacuum for the generation of plasma at very low energies through the ionization of gases by bombardment of the electrons generated by the cathode, regardless of the relative pressure of one (the cathode can be in high vacuum) and the other (gases to ionize).

The cathodes can additionally be used in an ionized gas (plasma) or generating plasma environment, both at high temperature and as cold cathodes below 250° C. with operation start from room temperature or even lower, which are used as ion beam neutralizers in aerospace electric propulsion, shaped as discs, hollow discs or hollow cylinders (“hollow cathodes”) to which part of the gas to be ionized is passed through them to improve the emission, and whether or not the union of the plasma of the neutralizer with the plasma to be neutralized (“plasma bridge”).

In this same environment, the cathodes can be used as electron generating devices for plasma generation in ionic thrusters, in this case preferably based on hollow discs and hollow cylinders (“hollow cathodes”) to which the gas to be ionized is passed through.

An additional application is the use of the cathodes working in an ionized gas environment (plasma) for the generation of the plasma itself with very low energies (achieved with less than 1 W power) through the ionization of gases by electron bombardment generated by the cathode.

This same environment allows the generation of plasma necessary for aerospace electric propulsion, using negative ions (such as iodine, I′ or others used in air propulsion through ions obtained from the sublimation of certain elements of high atomic weight or of the hydrolysis of water or other ionic compounds, such as oxygen).

Likewise, this last environment allows the cathodes to be used for the own generation of said plasma for material treatment (plasma etching) with very low energies, ion bombardment systems or ion guns in general, or also to provoke the dissociation of compounds in a gaseous state (such as ammonia, NH₃) through the ionization of its constituent elements (H and N in this case) or synthesis of certain compounds, generally in a gaseous state, (such as ammonia, NH₃) from the ionization of its constituent elements; having foreseen that in these cases the anode (10), is made of Pt, Pd, Mo, Ir, Ru, Ti, Ti+IrO₂ or Ti+RuO₂.

Another additional application is the use of cathodes for the manufacturing of electrolyzers (water electrolysis) where water molecules are in a liquid phase, where the water has some electrolytes (typically KOH) and using a simple molecular separation membrane of water with respect to hydrogen gas (as thin PFTE membranes and other polymers), where either negative pulsed polarization (17) or just negative DC polarization (16) is applied and where the anode (10), is made in Pt, Pd, Mo, Ir, Ru, Ti, Ti+IrO₂ or Ti+RuO₂.

In this same environment, water molecules can be pure, and are in a liquid phase, and a simple membrane is used for molecular separation of water with respect to hydrogen gas (such as thin PFTE membranes and other polymers), applying a negative pulse mode of polarization, forcing the ionization of water in the liquid phase without reaching plasma generation (although it might be generated) by separating the constituent ions of hydrogen and oxygen.

Finally, that cathodes can be used for the manufacturing of electrolyzers (water electrolysis) where the water is pure and is in a gaseous phase (water vapor) which is obtained by combining pressure and temperature conditions for minimal condensation, where a simple molecular separation membrane of water with respect to hydrogen gas (such as thin PFTE membranes and other polymers) is used, with the anode (10) being made of Pt, Pd, Mo, Ir, Ru, Ti, Ti+IrO₂ or Ti+RuO₂, applying a negative pulsed polarization mode (17) and forcing the production of ions in a gaseous state, whether or not forming plasma (convenient).

### BRIEF DESCRIPTION OF THE DRAWINGS

To complete the description that will follow, and to help for a better understanding of the characteristics of the invention, and following a preferential example of a practical implementation of it, a set of drawings are accompanied as an integral part of said description, as an illustrative but non-limiting nature, it has been represented the following:

FIG. 1 shows the crystal structure of the material C12A7:e-“electride”;

FIG. 2 shows the electrical behavior of an “electride” disk;

FIG. 2A shows a cross sectional view taking along line 3-3 of FIG. 2;

FIG. 3 represents one of the contacts made by sputtering (4) with a metal (ideally Mo and other alternatives described in the patent);

FIG. 4 highlights that the electron-emitting face cannot be metalized, while existing the dielectric layer (2), thus foreseeing the problems that, in fact, will face the “electride” in its main applications with conventional methods of polarization;

FIG. 5 illustrates the problem of “mass rebound” or “ground bounce” which is one of the most common root causes for the degradation of the “electride” in the conventional usage conditions;

FIG. 6 illustrates how to avoid material degradation due to oxidation;

FIG. 7 shows a typical configuration of using the “electride” as an thermionic electron emitter in high vacuum;

FIG. 8 shows the same mode of operation but using the cathode in a plasma environment instead of high vacuum;

FIG. 9 introduces another innovation that is the subject of this patent: the use of pulses to polarize the cathode instead of direct current (DC);

FIG. 10 details the use of a negative pulse generator in the case of operating the cathode with plasma.

FIG. 11 details another important problem of the cathodes manufactured with the material C12A7:e-“electride”;

FIG. 12 shows the emitter cathode fed with a negative pulse generator;

FIG. 13 incorporates the fundamental elements of the present invention;

FIG. 14 shows the different shapes of the negative pulses;

FIG. 15 details the final configuration of the invention, collecting all the innovations and their effects of improvement in the functioning of cathodes made with the material C12A7:e-“electride”;

FIG. 16 details a complete system based on an architecture also novelty that we call “hollow disk”;

FIG. 16A shows a cross sectional view taken along lines 32-33 of FIG. 16;

In FIG. 17, a conventional hollow cathode is used in the shape of hollow cylinder;

FIG. 17A shows the hollow cathode without the outer casing, with the metallization (4) both on the walls of the cylinder (optional but recommended) and on the back, that is, on the entire surface except the emission face and the interior of the cylinder;

FIG. 17B shows the hollow cathode with the insulating casing;

FIG. 17C shows a perpendicular cut to the bases of the cylinder (longitudinal) where the “electride” (1) can be seen with its dielectric layers natural (2);

FIG. 18.A shows detail a basic cell for electrolysis in which it is possible to use pure water (no added electrolytes to provide electrical conductivity) and without the use of specific proton membranes (PEM, Proton Exchange Membrane), both with water in the liquid phase; and

FIG. 18B shows detail a basic cell for electrolysis in which it is possible to use pure water (no added electrolytes to provide electrical conductivity) and without the use of specific proton membranes (PEM, Proton Exchange Membrane) with water in the gas phase or water vapor.

### DETAILED DESCRIPTION OF THE INVENTION

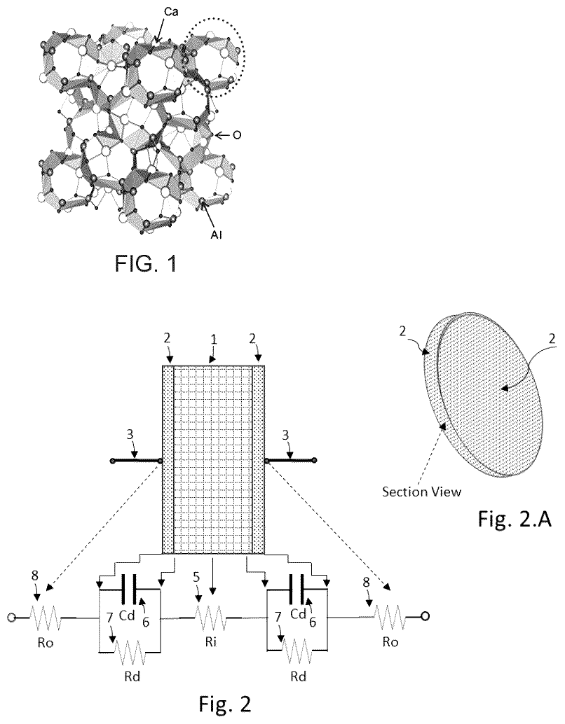

FIG. 1 shows the crystal structure of the material C12A7:e-“electride”. Both central oxygens, existing in the center of the union of two basic boxes of C12A7, are replaced by four electrons, transforming it into C12A7:e-“electride”.

FIG. 2 represents the electrical nature of an electride disk (typically 25.4 mm in diameter and between 1 and 2 mm in thickness, although it may vary according to needs). The “electride” (1) has a dielectric surface (2) due to the impossibility of maintaining the electrons confined to the boundary of the material (surface). Although the “electride” has a small resistance (5) Ri (less than 0.1 ohm in a quality “electride”, corresponding to a conductivity greater than 1 S/cm, better if reaching 10 S/cm and desirable higher than 20 S/cm), when making external contacts (3) it is confirmed, and measured, the existence of a large resistance (6) (greater than 10 Kohm at room temperature) in parallel with a capacity (7) formed by the dielectric surface itself and the external contact that will be greater for a superior surface contact, ideally covering the entire surface contact (3).

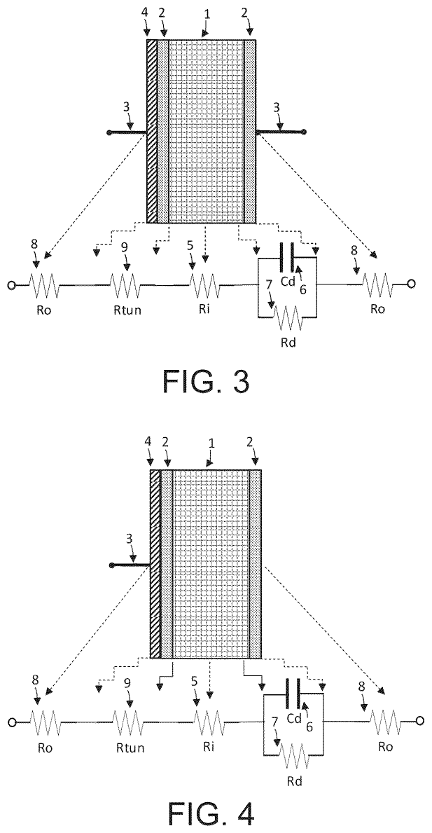

FIG. 3 represents one of the contacts made by sputtering (4) with a metal (ideally Mo and other alternatives described in the patent). This technique allows massive tunnels to exist due to the high doping of the “electride” (>10²⁰ cm⁻³), typical characteristic of a metal-semiconductor junction when the semiconductor is degenerate (heavily doped). The resistance on that side approaches a conventional ohmic contact (8 and 9) reducing the complete conductivity of the total path from the contact to the other side of the “electride” (Rₒ+Rₜᵤₙ+Rᵢ).

FIG. 4 shows that the electron-emitting face cannot be metalized, existing the dielectric layer (2), foreseeing the problems that, in fact, will face the “electride” in its main applications with conventional methods of polarization. Among them, the reduction of one or two orders of magnitude of the emitted current due to the existing series resistance.

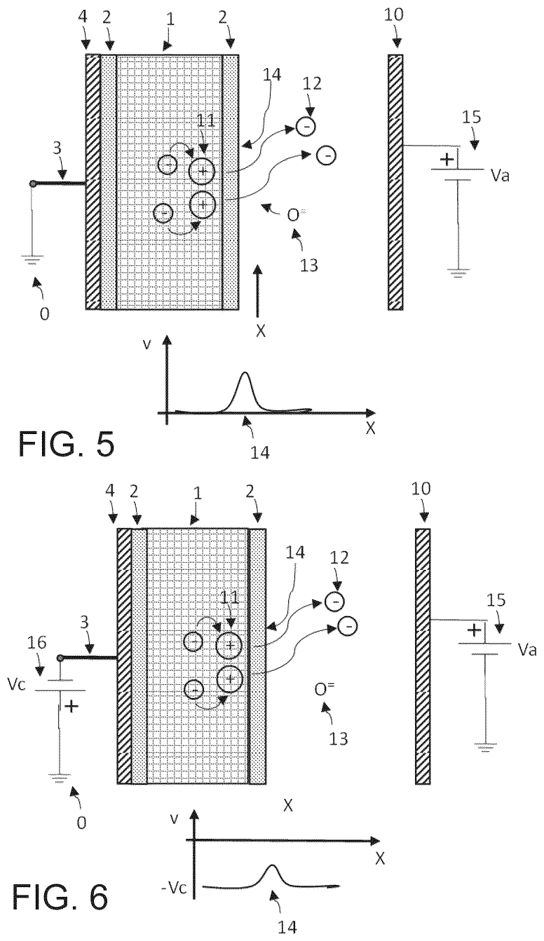

FIG. 5 illustrates the problem of “mass rebound” or “ground bounce” which is one of the most common root causes for the degradation of the “electride” in the conventional usage conditions. When thermionic emission of electrons occurs (12), momentarily a small part of the surface (11) remains positively charged (11) in a few nano square meters. Since the mobility of the electrons of the material is very small (between 0.1 and 4 cm²/V.s) and the cells are relatively large (1.2 nm) and not all of them, statistically, have electrons, so there is a jump in electrons from one cell to another has to cover a greater distance (typical “hopping” conductivity of some semiconductors), resulting in a transit time or time to fill the charge gap much larger than in other semiconductors such as Silicon (100 or 200 times faster), and can be up to 5 micro seconds. During that time, the potential profile on the surface presents a positive potential peak (14) just at the exit point of the emitted electrons. Since the surface is dielectric, and therefore it is not possible to maintain the equipotential surface as in a conductor, said peak remains in time at that point until the charging gap is filled. If there are some oxidizing ions present, such as ionized oxygen (13), the probability of such an ion arriving first than the internal neutralizing electrons is not only not zero but can become significant, as proven in various experiments. After a short time (less than an hour) in an even low-oxidizing environment (with partial pressures of oxygen of the order of 106 atm) the degradation of the material is complete. In literature it is recommended to work with oxygen partial pressures in the order of 10-20 atm and/or protect as much as possible the material with graphite (several patents), minimizing, as much as possible, degradation. This patent presents a solution that avoids the cause instead of trying to minimize the effects, as has been done until now.

FIG. 6 illustrates how to avoid material degradation due to oxidation (there are other degradations that will also be discussed in this patent). It consists of using a negative potential (16) with respect to ground to feed the cathode, instead of connecting it to ground as most current systems do. Even more, the rule should be to polarize the cathode as negatively as possible with respect to the rest of the subsystems. In this way, the “ground bounce” is hidden within the negative potential so that no absolute positive potential with respect to ground is being possible at any moment on the surface. In this way, it is completely unlikely that an oxygen ion (or OH or similar) can overcome the potential barrier and fill the gap left by the emitted electrons, keeping the material free of oxidation even in media with relevant content of oxidant ions. This ability will be key for some space applications (in case of propellants that are not noble gases and are liable to negative ionization such as Iodine) and in water electrolysis applications, H₂ fuel cell, water treatment and, in general, in applications where interactions with any type of ions is taking place.

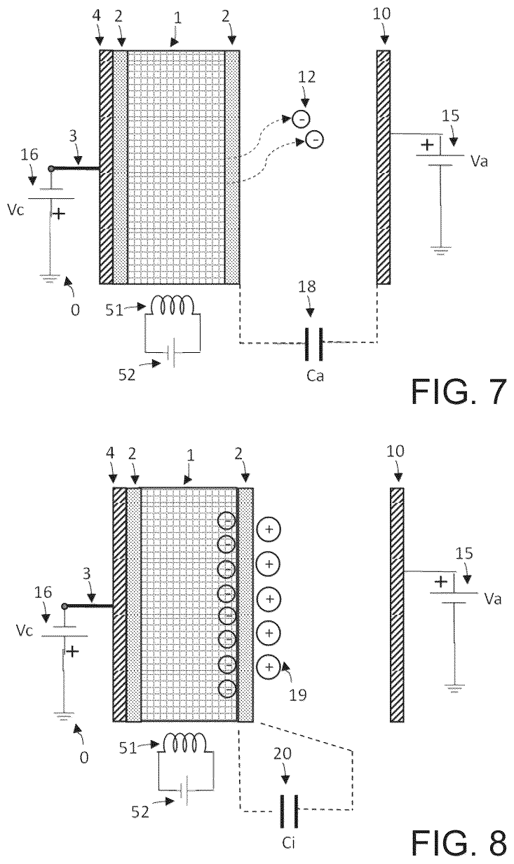

FIG. 7 shows a typical configuration using the “electride” as a thermionic electron emitter in high vacuum (solved the problem of degradation by oxidation). Although the material has a low work function, it has a low current of electrons emitted (of the order of 1 to 5 mA at maximum temperatures of 900° C. to 950° C.) due to the high resistance of its dielectric surface and that it cannot be metalized without losing the properties of the material itself, nor can it be over-doped with other conductive or semiconductor materials, as many authors do in order to increase the conductivity since the main characteristic of the material that is its low work function will be jeopardized. Therefore, the challenge posed is to solve the problem of conductivity of the surface without altering the intrinsic characteristics of the material, especially its low work function. In addition, this configuration requires a heater (51) that brings the material to the optimal temperature of emission (between 800° C. and 950° C.).

FIG. 8 shows the same mode of operation but using the cathode in plasma environment instead of in high vacuum. Once a certain temperature is reached (above 350° C. with the present invention and higher than 700° C. in the rest) it is possible to turn off the heater (51), maintaining the temperature thanks to the bombardment of plasma ions. Although it is the so called “heaterless” cathode, in operation, the heater is necessary for startup, so ignition is not instantaneous and requires several minutes. In this case, furthermore, a capacitance Cᵢ (20) is formed in series with the capacitance of the dielectric layer on the surface of “electride”. Obviously, this capacity Ca is much greater than in the case of high vacuum (18) from the previous figure, so the coupling with pulses is much better. In fact, there is an intense field perpendicular to the surface due to the accumulation of charge on both sides of the dielectric layer of the “electride”, an aspect that favors the Schottky effect decreasing the effective work function or enhancing the emission because of such field (“Field Enhanced Thermionic Emission”). This fact is verified experimentally, being the electron current obtained from one to two orders of magnitude higher than in high vacuum mode (absence of ions).

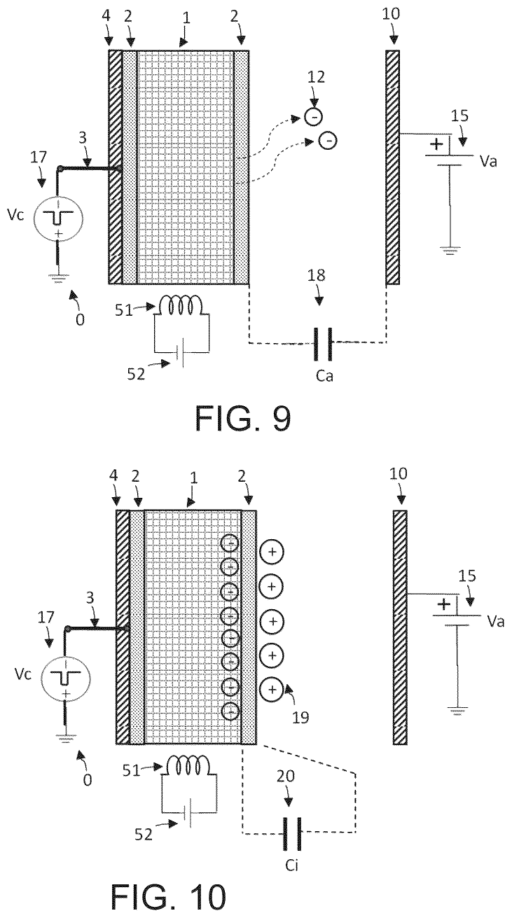

FIG. 9 introduces another innovation that is the subject of this patent: the use of pulses to polarize the cathode instead of direct current (DC). Adding to the previous conclusion, the pulse generator (17) will have negative pulses, thus avoiding degradation due to oxidation, as previously described. Even more, this configuration is the only one possible to obtain a significant electron current in high vacuum conditions when charge coupling occurs between the inside of the semiconductor “electride” and the anode through two series capacitors, C_{d} (6) and Cₐ (18).

FIG. 10 details the use of a negative pulse generator in the case of using the cathode with plasma (and, in general, in any ionic medium). In this case the charge coupling is more effective given that Cᵢ (20) is much greater than Cₐ (18) so that the electron emission is doubly favored: emission due to the electric field effect (Schottky) and charge coupling thanks to the cathode polarization mechanism.

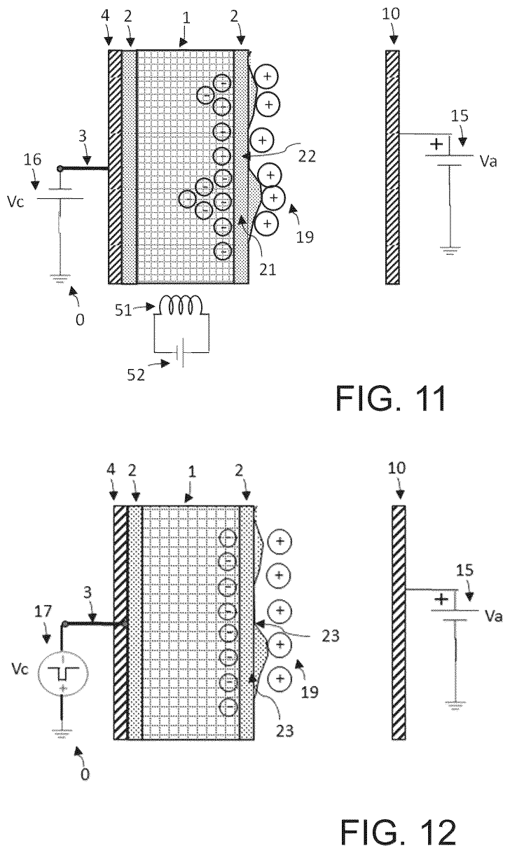

FIG. 11 details another important problem of cathodes manufactured with the material C12A7:e-“electride”. With conventional polarizations, using direct current (DC) and in an environment with plasma (ions), we can observe continuous instabilities that cause strong and sudden discharges that reach tens of Amperes and even higher currents. Consequently, in addition to an unstable and significantly uncontrollable functioning, a strong degradation of the “electride” surface is taking place. This fact is due to the presence of fractures, dislocations, and defects on the surface, originated mainly during the cutting and machining processes of the samples, which cause an extension in thickness of the dielectric layer. The thickness of the layer in the case of a perfect crystal on its surface usually has a few nano meters (less than 20 nm in general). In that case (22), the electrons are emitted by tunnel effect, just as happens when metallizing the electrical contact surface of the cathode, allowing a homogeneous and controllable emission in direct current (DC). However, in areas where the width of the “electride” dielectric layer reaches several tens of nano meters, even hundreds of nano meters and even exceeds a micron (21), the tunnel effect has a low probability, very close to zero, so the current is zero. In this case, the excessive charge accumulation causes the breakdown voltage of the dielectric layer to be reached. When this circumstance occurs, reaching the breakdown voltage before the tunnel conduction, the result is a sudden emission of high current density of emitted electrons that do not correspond to the capacity of the power source used to power the cathode (neither in voltage nor current capacity) since it is originated from the accumulation of charge over time. The thicker the dielectric layer is at certain places, the more charge accumulates and the greater the current density instantaneously discharged when reaching the breakdown voltage. There is an intermediate situation of accumulation of charge reaching the tunnel effect before rupture that manifests itself in multiple micro current pulses superimposed on the continuous emission (DC). These discharges, on the other hand, not only cause the progressive deterioration of the cathode surface but can cause serious damage to the rest of the system (functioning as neutralizer or as a cathode for ionic propellant) and to the power supply itself.

FIG. 12 shows the emitter cathode fed with a negative pulse generator. In this case the charge coupling is forced, especially on the flanks of the pulses and more specifically on the 0 to −V_{c} edge, so that the discharge of the dielectric layer practically independent of its thickness. That is, although it has a greater flank conductivity the thinner it is, the dependence is continuous (conductivity equal to Cᵢ.ω) while the tunnel effect decreases exponentially. This implies the material impossibility of accumulating charge over time, even when the thickness of the dielectric layer is of the order of microns, and therefore the stability of the emission is maintained over time avoiding uncontrolled and random discharges that could deteriorate the surface of the “electride” and make its application unfeasible.

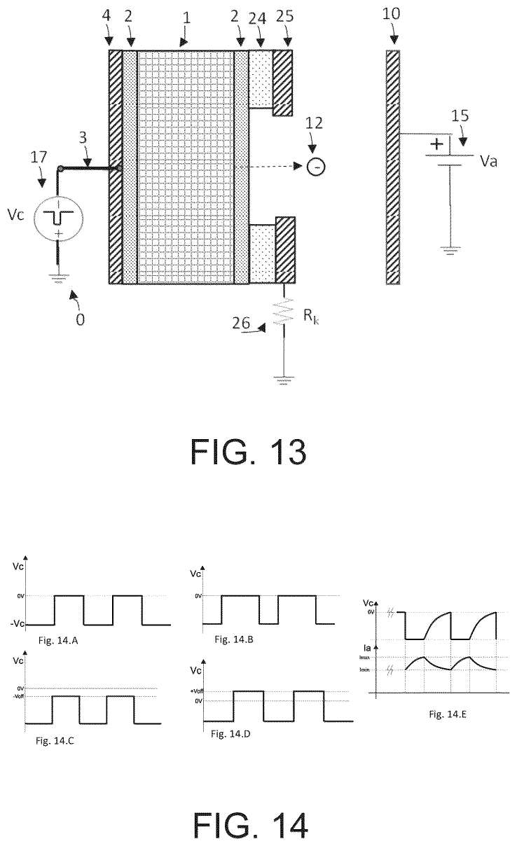

FIG. 13 incorporates the fundamental elements of the present invention. On one side, the use of negative pulses as polarization of the cathode, and on the other side to force a charge coupling mechanism through a conductor (25) (“keeper”) so that the system is valid both for high vacuum and for use in the presence of ions (plasma or ionic medium). The conductor may be installed through thin dielectric spacers (24) (between 0.1 and 1 mm) for which materials such as mica, quartz, alumina and different dielectric oxides can be used, or may be deposited by sputtering directly on the cathode both the dielectric in question (ideally Hafnium oxide, with high electrical permittivity and, therefore, with high dielectric capacity and, at the same time, with a coefficient of thermal expansion very similar to the “electride”, (of the order of 6.10⁻⁶) which makes it the most suitable. On said oxide, it is then deposited, by the same sputtering or evaporation process or similar, a metal conductor, ideally molybdenum, Mo, as stated in the detailed description of the patent. With specific techniques (not the subject of this patent in terms of its implementation procedure but in terms of its architecture and functionality), a vacuum dielectric micro channel can de achieved, with the metal electrode (25) at tens of nano meters of the “electride”, with only the thickness of the oxide (24) as separation, but with an area without dielectric between said metal and the “electride” (empty channel) which implies a high emission current density because of entering into the Schottky effect region. This structure would be equivalent to a MOS transistor with empty channel (instead of oxide), but with a vertical effective channel instead of horizontal as is usual.

FIG. 14 shows the different shapes of the negative pulses. Regarding the frequency and amplitude, considerations are included in the detailed description. The signal cycle is an important aspect depending on the nature of the environment in which it is use the electron-emitting cathode, thus, in vacuum it is usually optimal around 50% (FIG. 14.A) but in ionic media, depending on the relaxation time of the plasma (extinction) it is possible to decrease the active (negative) part of the pulse as long as the current obtained is within the desired Imax-Imin ranges (FIG. 14.E), that range will depend on said relaxation or extinction time of the plasma. The cyclical relationship and Imax-Imin parameter depends strongly on the frequency. For space environments (cathodes for ion neutralizers and thrusters) the range of 50 KHz to 200 kHz is adequate, with a duty cycle of 10% to 50% (duration of the active part with respect to the duration of the complete cycle). With high ionic concentrations (electrolysis, batteries H₂ fuel or high-density plasmas) it is convenient to adjust the frequency and duty cycle to the relaxation time and, consequently, the extinction constant of the active ions. Finally, a crucial factor is the “offset” or continuous component superimposed on the pulse. The positive “offsets” (FIG. 14.D) are very useful for removing charge from the surface of the “electride” in certain applications (in some cases of electrolysis or pulsed plasmas) but, in general, they can be very harmful. Indeed, they cause a withdrawal and subsequent bombardment of the ions with greater kinetic energy to produce “sputtering” on the surface of the “electride” (in essence they are the basis of HiPIMs next generation sputtering systems). The negative “offsets” (FIG. 14.C), on the other hand, represent a protective barrier for the surface of the “electride” against the bombardment of ions although they can penalize the effective current density. However, the benefits (durability and reliability) far outweigh the drawbacks in

The final density current, especially for space applications (cathodes for neutralizers and ionic thrusters). On the other hand, said negative “offset” cannot be very large (less than 10% of the signal amplitude and, in any case, less than 10 V at an absolute level) to avoid the problem of the DC regime (direct current) that, precisely, this is what the present invention seeks to avoid. This pulse form factor is another innovation of this invention.

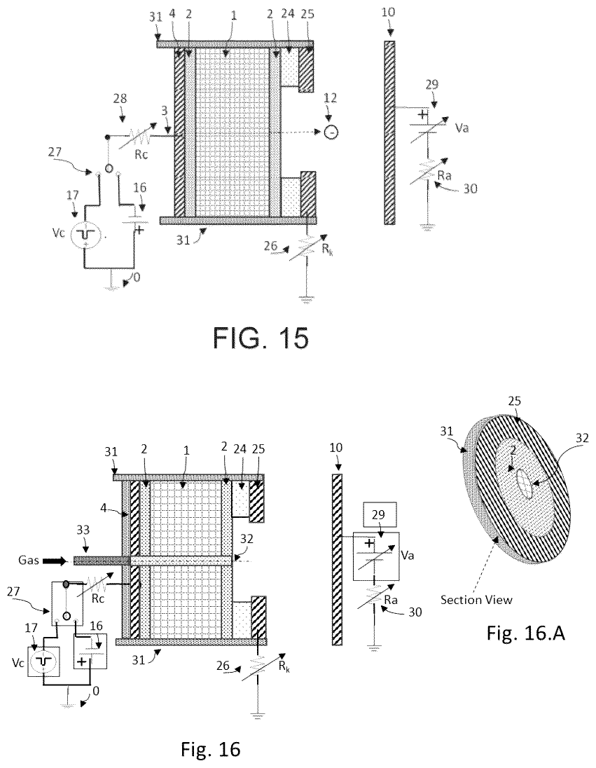

FIG. 15 details the final configuration of the invention, collecting all the innovations and their effects of improvement in the functioning of cathodes made with the material C12A7:e-“electride”. A very important functionality of the invention is that it allows completely cold starting ignitions (“cold cathodes”), and hence, the absence of the heater (51) represented in the previous figures. This is due to the own pulse coupling (with high impedance of the dielectric layer of the “electride”). When used with plasma, the bombardment of the ions progressively causes the heating of the cathode (like the conventional “heaterless”). In high vacuum, the coupling with the electrode (25) (“keeper”) allows the target temperature to be reached. While the system is in coupled pulse mode, there is no damage to the cathode, as explained above, so the heating occurs with the operation itself, both at high vacuum as in the presence of plasma. Once the target temperature is reached, it is possible to operate in continuous mode (DC) (16) or continue in pulse mode. It is important to highlight that in pulse mode it is not necessary to raise the temperature above 200° C.-250° C. while that to operate in DC mode it is necessary to reach at least 800° C. in high vacuum and at least 350° C.-400° C. with plasma. This happens because heating decreases heavily the resistance Rd (7) of the dielectric layer of the “electride”, decreasing the penalization in current density and the instabilities. The possibility of using any of both sources, DC and pulses (16 and 17), allow a wide flexibility depending on the type of application, although, in any case, the pulse mode will always be more stable than the DC mode even for high temperatures.

It should be noted that the coupling electrode (25) (keeper) does not act in grid mode as if it was a conventional triode but rather as a charge coupling element. This concept is totally new and only in this case it has been possible to reach a real feasible implementation. In fact, you can limit the current needed for coupling through the resistor Rₖ (26) in the range of 500 ohm to 100 Kohm, obtaining current values of anode (10) around 99% of the cathode current, that is, less than 1% of the cathode current spent in the “keeper”, being emitted and reaching the anode practically all the current provided to the cathode, even with zero or negative anode voltages Vₐ (29), which represents a characteristic not observed so far in any system.

FIG. 16 details a complete system based on an also novel architecture that we call “hollow disk”. Normally the hollow cathode has a tubular shape (hollow cylinder) with a diameter smaller than its length, producing emission (and ionization of the gas used) along the inside of the tube and especially in the vicinity of the exit hole (32). In the case of conventional hollow cathodes tests carried out with the “electride”, the concentration at the exit orifice is maximum. Since charge coupling is used in the present invention in the emission surface, the larger the surface just at the exit, the better the coupling. By degeneration of the hollow cylinder, we reach the “hollow disc”, much more effective, stable, and controllable than the conventional hollow cylinder. The disk, containing the separators (24) and the metal electrodes (25) (keeper) or even better and more integrated and effective, with an oxide layer (ring) and the metal electrode itself deposited by sputtering, provides all the essential elements. On the back face (contacting), a metal (4) has been deposited (ideally Mo) and the set of elements is preferably assembled with insulating materials (31) that prevent losses, unwanted discharges, and areas of uncontrolled plasma. The gas is fed through the center (33) and the contacts are moved to the back side where it is very convenient to use RF connectors (type BNC, F, N, UHF or similar depending on the pulse width so that they withstand the maximum applied voltages). It is possible to use the gas tube itself (33) (typically “1/4” or “1/8” inch stainless steel), insulated with alumina, as the “keeper” coupling electrode itself. It is a simple, reliable solution that can be used in many applications.

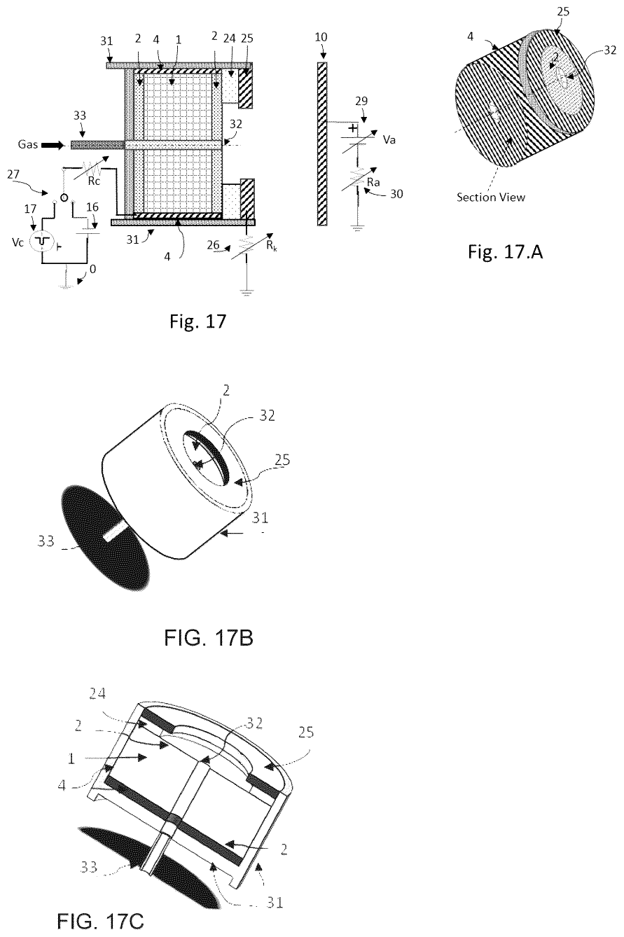

In FIG. 17, a conventional hollow cathode is used in the shape of hollow cylinder. It should be noted that until the moment of the presentation of this present invention, no hollow cathode made with C12A7:e-“electride” has been presented that works stably beyond a few hours. This fact is due to the problems noted above while the hollow cathode inserted in the device under the present invention and polarized in the way that has been detailed, not only works stably but also significantly increases the emitted current density compared to current devices, in addition to achieving a spectacular relationship between the current emitted and collected in the anode with respect to that injected into the cathode by the source of 99%, both in DC and with pulses, once the desired regime has been achieved from room temperature with its own pulses. There is no known device that has this feature. The FIG. 17.A represents the hollow cathode without the outer casing, with the metallization (4) both on the walls of the cylinder (optional but recommended) and on the back, that is, on the entire surface except the emission face and the interior of the cylinder. The FIG. 17.B collects the hollow cathode with the insulating casing and 17.C a perpendicular cut to the bases of the cylinder (longitudinal) where the “electride” (1) can be seen with its dielectric layers natural (2), the metallization of the walls and the lower base (4), the exit hole of the gas (32) as well as its inlet (31), the dielectric (24) made either via spacers (between 0.1 and 1 mm) or via a thin oxide film deposition (generally HfO₂) of tens or hundreds of nano meters and the charge coupling metallization (25) that can performed with a metal crown on top of the spacer or by deposition of thin film of hundreds of nano meters on top of the oxide. The most suitable metals are Mo preferably, and as a second option Pt, Pd, Ta, W and even graphite. Metals that are not diamagnetic (for example Nickel) are not recommend due to the large expected losses when exposed to pulsed polarization.

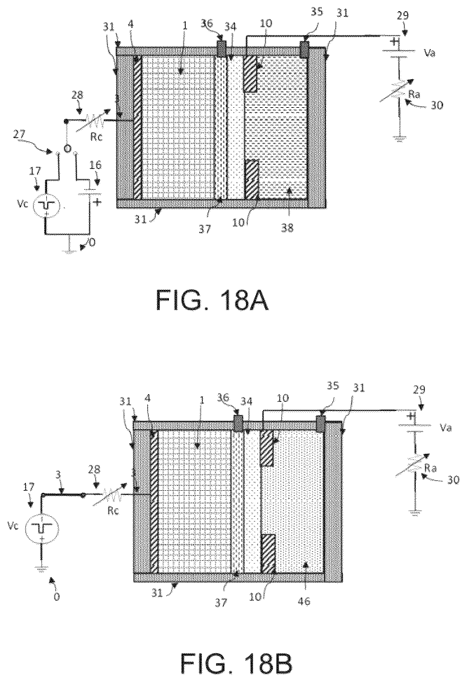

In FIGS. 18.A and 18.B a basic cell for electrolysis is described, where it is possible to use pure water (without added electrolytes to provide conductivity electrical) and without the use of specific proton membranes (PEM, Proton Exchange Membrane), both with water in the liquid phase (FIG. 18.A) and with water in the gas phase or water vapor (FIG. 18.B). The membranes (34), in this case, must allow the gas to pass hydrogen and any type of ion, whose function is the retention of the water molecules. Typical membranes for this function are thin PTFE membranes (0.1 to 1 mm). The cathode made with the material C12A7:e-“electride”, as well as the arrangement of elements and concepts introduced in the present invention, enable the separation of charge since the emission of electrons occurs only in one direction (from the cathode to the anode). That is, the configuration is similar to diodes based on thermionic emission tubes. Therefore, the membrane does not have to distinguish the charge, positive or negative, but the molecules, not allowing liquid water (38) or the vapor phase (46) to pass into the gas diffusion (37). This phenomenon has not been found implemented in any device so far and represents a fundamental advantage over one of the elements most critical for electrolyzers based on PEM membrane, which is precisely said membrane. On the other hand, water can be pure since a charge coupling between cathode and anode takes place, and not a continuous current. The water has a very high relative dielectric constant (εr around 80) which makes it precisely in an ideal dielectric with very low losses at high frequencies (pulse edges). In the case of pure liquid water (FIG. 18.A) and in the gaseous state (FIG. 18.B), only the pulse regime (17) is used. The anode (10) can be made of usual materials with high work function (Pt, Pd, Ir, Ti+IrO₂, etc.). H⁺ ions are neutralized by the cathode, whose emission is favored precisely by said ions (protons) as they are the smallest possible ions and achieve a maximum approach to the active zone of the electride, even being adsorbed by the dielectric layer, a fact that favors emission by electric field (Schottky) and that has been repeatedly proven at the laboratory. In contact with the cathode there is a gas diffusion membrane, normally made out from graphite and very porous polymers, to allow diffusion of H₂ and its exit through the corresponding tube (36). Oxygen ions (or more specifically OH ions), due to the characteristics of the invention that have been detailed repeatedly, they do not cross the membrane (34) since they encounter a potential barrier on the surface of the “electride”, recombining at the anode as molecular oxygen (O₂) that is collected through the tube (35). To do this, the anode must facilitate oxidation, capturing electrons. This function is appropriate for elements and compounds complementary to the “electride”, such as Pt, Pd, Ir, IrO₂, etc. characterized, precisely, by their high work function. Both the polarization of pulsed cathode and DC as that of the anode (29) (not strictly necessary since it can be zero volts) can be adjusted both in amplitude (Vₚᵤₗₛₑₛ and V_{c}), “offset”, as well as the own current density through R_{c} (28) and Rₐ (30) resulting in electrolysis and, therefore, H₂ production completely on demand and very controllable. The pulsed polarization can, as previously commented, heat the cathode and significantly increase the performance of the electrolyzer, added to the fact of the low “electrode overpotential” at the cathode being constructed with the material C12A7:e-“electride” due to its low work function. Al elements are within a hermetic container (31).

Stack layout it is also possible to build an electrolyzer, stacking cathodes-membrane-anodes since it is the most suitable architecture of the present invention: depositing layers or thin oxide films on the cathode that implement the dielectric and thin layers of metal for the electrodes themselves (anode in this application). In this case, the water retention membrane which allows ions to pass through is physically necessary, and the anode can be made through the deposition of a thin film of the materials suitable for said anode, which, as detailed, must have a high work function: Pt, Pd, Ti+IrO₂, etc.).

The material C12A7:e-“electride” is obtained from the material dodecacalcium hepta-aluminate (mayenite, 12CaO·7Al₂O₃, Ca₁₂Al₁₄O₃₃ or C12A7). It is a ceramic material known as alumino-calcium cement. Since 2004, the team of Professor H. Hosono [1], from the Institute Tokyo Technological Institute, have been detailing additional properties of said material when subjected to a series of transformations. The most relevant consists of the replacement of two oxygen ions by four electrons neutralizing the global charge every two cells, that is, the four negative charges of the two substituted oxygen ions are replaced by four electrons, resulting in a neutrally charged and stable crystalline structure (FIG. 1). This process can only be carried out due to the physical and geometric characteristics of the crystalline structure of C12A7 ceramic because it has two oxygen ions in the central part every two cells. The result is a new material, completely different in electrical properties, which belongs to the group called “electrides” whose common characteristic is the arrangement of a certain number of electrons as anions, that is, forming part of the crystalline structure as if they were ions (the “bricks” with which build the crystalline structures) but without belonging to the orbitals of any ion in particular acting as negative ions (like “bricks” of the structure). In some way, it can be stated that the four electrons existing in every two cells are “confined” in the center of two C12A7 crystalline cells, maintaining the structure stable at room temperature and conventional atmosphere. Therefore, we will refer to the transformed material as “C12A7:e-”, “C12A7 electride” or simply “electride”, as the material resulting from a massive substitution of oxygen ions by electrons. In fact, one of the parameters that determines the quality of the electride is the degree of substitution with respect to the maximum possible 2.3*1021 electrons per cubic centimeter (represented by cm⁻³).

The new electrical and electrochemical characteristics of the “electride” incorporate the following properties: it is a semiconducting material (type n) from concentrations of 1019 cm³ to 1.5*1021 cm⁻³ reaching conductivities of up to 300 S/cm, and it is getting metallic conductor properties at very high concentrations (1.5*1021 cm-3 to 2.3*1021 cm⁻³) reaching, in this case, conductivities of up to 1500 S/cm; The material remains stable up to 150° C. in any type of atmosphere and up to 1000° C. in non-oxidizing atmospheres or high vacuum; it has a very low work function, 2.4 eV, which makes it an ideal material for thermionic emission of electrons, outperforming other compounds such as LaB₆ (with work function above 3 eV) and being much more stable at high temperatures than materials such as BaO or certain “cesiated” compounds (with Cesium) or Sc-based (“scandiated”).

Thermionic emission is governed by the Richardson-Dushman equation: J=AT²e^{-φ/KT}, with J being the current density (A/cm²), A constant resulting from the product Aᵣ*Aₘ, with Aᵣ being the Richarson-Dushman constant 120 A/cm² and Am a characteristic constant of each material, T the absolute temperature (in degrees Kelvin° K), K the temperature constant Boltzmann (8.6173*10⁻⁵ expressed in eV.K⁻¹), and @ the work function (expressed in eV). It is obvious that the smaller the work function o of a material, the lower the temperature necessary to achieve the emission of electrons. On the other hand, when the surface of a material is subjected to intense electric fields, it is possible to produce the emission of electrons at lower temperatures since in this case the previous equation now incorporates the Schottky correction according to the form: J=AT²e^{-φ-φs)/KT} with φs being Schottky potential which, in turn, is given by the expression: φs=((e³E)/(4TTε₀))^{1/2}, where e is the charge of the electron (1.6*10⁻¹⁹ C), E is the electric field (V/m), Eo is the constant vacuum dielectric (8.85*10⁻¹² F/m). For practical purposes, with fields greater than 105 V/m the Schottky potential begins to be comparable to the work function, reducing the exponent and the emission occurs at lower temperatures. With intense fields (greater than 107 V/m) the emission occurs due to said potential, regardless of the temperature. This is what is called field-enhanced emission or field effect emission (Field Enhanced Thermionic Emission). This effect is of upmost importance in the object of the present invention.

There is an intrinsic contradiction in the “electride” itself: having a low work function, It has a tendency to give up electrons and that makes it unstable by nature since it will fill the gaps left by the electrons with negative ions, especially O₂^{═}and OH⁻ and loose the electride nature. However, it is stable as electride. The alkali and alkaline-earth elements (Li, Na, K, Rb, Cd, Be, Mg, Ca, Sr, Ba) all have a low work function (between 1.5 and 2.9 eV) and all are unstable even at room temperature in oxidizing atmospheres or in the presence of elements with which they can react and therefore are not used for the manufacturing of electron-emitting devices except for some combinations (BaO, ScX, etc.), always very susceptible to degrading in uncontrolled atmospheres and, above all, at high temperatures.

The “protection” is due to the formation of a dielectric (non-conductive) layer on the “electride” surface due to the physical impossibility of finishing the crystalline cells at the edge of the material keeping the electrons confined. This model was initially formulated by the team of prof. H. Hosono (Tokyo Institute of Technology) in 2011 [2] and subsequently simulated with models based on density functional theory in 2019 in laboratories in Tokyo and Washington [3]. These theoretical models are in line with all experimental verifications carried out for several years by the applicant of the present invention through numerous tests, characterizing the circuit equivalent of the material (FIG. 2). The dielectric layer has a thickness from a few nano meters (nm) for “electrides” of high quality in their crystalline structure, without defects or fractures on its surface, up to hundreds of nano meters and even microns in cases of dislocations, fractures, and other defects on the surface. The result is a resistance much larger (non-conductive layer) than the intrinsic resistance (Rᵢ) of the “electride” that depends on the electron concentration of the sample considered, and in parallel, a capacity (capacitor) that will be formed between the “electride” and any external electrode or ionic interface through the dielectric layer.

There are only two possibilities to minimize the effect of the dielectric layer:

1.-Make a “quasi-ohmic” contact through the deposition of thin layers of metals or by close contact with suitable conductors (such as graphite) (FIG. 3). Given that the electron concentration must be, for a quality “electride”, greater than 1019 cm³ and even higher than 10²⁰ cm 3 preferably, metallurgical joining with a metal is similar to a Schottky union of a “degenerate” semiconductor (with high doping) and a metal (Schottky diode) producing, in this case, massive tunnels (quantum tunneling effect). The result is a good approximation to a conventional ohmic contact, with low losses despite the existence of the dielectric layer. Experiments have confirmed that the improvement in the contact (few ohmic losses) is better the greater the concentration of electrons in the “electride” is, especially when low level of defects, dislocations and fractures exist in the surface which are the cause of a thicker dielectric layer. The deposition of thin metal layers is carried out mostly with “sputtering” techniques either DC, Pulsed-DC or HiPIMS (High-Power Impulse Magnetron Sputtering), but any other metal deposition technique could also be used (evaporation, PLD, etc.). Regarding the most suitable metals, it has been found that Molybdenum (Mo) is very suitable, with low reactivity with the “electride” at high temperatures, good adherence and resistance to high temperatures, followed by Titanium (Ti) although it is not very suitable for very high temperatures in vacuum (above 900° C.), given their high degree of evaporation and reaction with the “electride”. Pt and Pd are suitable up to intermediate temperatures (up to 600° C.) due to its loss of adherence at high temperatures, as well as Ta and W. Finally, Au, Ag and Cu are only suitable at low temperatures (up to 350° C.) and/or high pressures (more than 1 Torr) due to its high degree of evaporation, while Ni, Co, Fe are not suitable given their ferromagnetic characteristics incompatible with the pulsed polarization regime that constitutes the central core of the present invention. Graphite is always suitable at any temperature, if it is not in an oxidizing atmosphere. Since the “electride” already requires non-oxidizing atmospheres from 150° C., graphite will always be compatible with the “electride” given that its maximum temperature for oxidizing atmospheres is higher.

2.-Through the charge coupling between the “electride” and the outer electrode or the ions with which it exchanges (transfer of electrons by the “electride”) (FIGS. 9, 10, 11, 12 and 13). That is, through an alternating signal, ideally square wave or pulses, and necessarily always with negative pulses. This way of polarizing the “electride” constitutes the basis of the present invention, since the pulses (especially the edges of the pulses) represent a forced coupling with the inside of the “electride” regardless the thickness distribution of the dielectric layer that is not uniform on the surface of the “electride” due to defects, dislocations, and fractures on said surface. In case of polarization with direct current (DC), the areas with a thin dielectric layer will have an acceptable conductivity due to the tunnel effect but areas with thicker layers due to surface imperfections, will have excessive charge accumulation since no tunnel effect is taking place, which causes the dielectric layer to reach the breakdown potential, producing excessive current peaks, instabilities, and progressive deterioration of the “electride” emission surface.

Issues of the “electride” with conventional polarization in direct current DC.

As described above, the direct current (DC) polarization of the “electride” not only has the issue of high impedance due to the dielectric layer unavoidable by the nature of the “electride”, but also presents other proven problems for which, until now, there have been no solution.

The dielectric layer of the emitting surface cannot be metallized to enable the conductivity by tunnel effect and to avoid the high impedance of said dielectric layer since it must be free precisely to allow thermionic emission of electrons.

At high temperatures (between 800° C.-950° C.) an improvement (decrease) in impedance is observed on the surface due to the positive characteristic of conductivity with the “electride” temperature, characteristic of semiconductors (higher conductivity at higher temperatures, unlike metals) but also instabilities consisting in multiple superimposed pulses of electron emission together with large random discharges that degrade the surface of “electride” emission.

A lot of energy is necessary to heat the samples of “electride”, other than deposited thin films, due to its high thermal emissivity (above 0.9), to its high specific heat value (around 1.1 J/gr.K) and, above all, to the low thermal conductivity of the material (1.5 W/K·m). This fact is also causing heat concentrations in specific points that emit more electrons being hotter and having less impedance, reducing, in turn said impedance by increasing the temperature and, as a consequence, emitting even more electrons. This fact constitutes positive feedback from temperature at certain random points (“runaway”) that even cause the melting of the material. This fact is especially evident in hollow cathodes that do not work properly for more than a few hours, with strong instabilities and melting of the material in the vicinity of the exit orifice.

Regardless of the previous problems, a progressive degradation of any cathode built with the material C12A7:e-“electride” is observed, due to generalized oxidation or passivation of the emission surface that completely renders the system useless with large drops in the emission rate that even gets cut. This fact is widely described in the literature [1], [5]. The solutions proposed so far are based on reducing to almost extremes the partial pressure of oxygen and other oxidizing agents (10⁻²⁰ atm) [1] or protect the material as much as possible with graphite even included in patents [US Patent 2014/0354138A1], which greatly limits the design possibilities and greatly increases significantly the energy needed to heat the cathode, decreasing notably the energy efficiency of the system.

Core of the invention. Negative pulsed polarization system, auxiliary electrodes for charge coupling and general characteristics of the design of the cathodes built with the material C12A7:e-“electride”

The solutions to the previous issues are detailed hereafter, and they constitute the objective of the present invention. With these solutions, it is possible to obtain high-performance electron emitter cathodes by taking advantage of the characteristics of the material C12A7:e-“electride” while avoiding its issues.

Need and characteristics of pulses. As previously described, the minimum impedance of the dielectric layer occurs on the rising and falling edges of a signal square. The capacitor approaches a short circuit, perfectly coupling the signal between the “electride” and the outer electrode or the ions. If the pulse is too long, the electron emission will fall to minimum values established by the resistance Rp, equivalent to a DC polarization used in practically all current systems. On the other hand, the pulses have a limitation in frequency because the “electride” itself tends to be a capacitor (regardless of the dielectric layer) at high frequencies. This effect is due to the low mobility of carriers (electrons) in the “electride”, established between 0.1 and 4 cm²/V.s depending on the concentration of No electrons of the considered sample, which is two or three orders of magnitude smaller than that of Silicon, for example. If the signal changes faster than the time it takes for the electrons to “hop” between cells of the “electride” (hopping conductivity characteristic of the “electride” such as semiconductor) complete signal transmission does not occur before change the signal itself, resulting in instabilities, unwanted charge concentrations and distortions. This concept is called “cutoff frequency” in devices semiconductors and assumes the maximum frequency of operation without distortions, instabilities, or charge accumulations. This fact causes severe instabilities in the use of the material due to the accumulation of charge produced in a cycle that appears in the following as a current response higher than the applied potential. It is established a cut-off frequency or maximum pulse frequency, which depends on the concentration of electrons of the “electride” considered, between 150 kHz and 900 kHz, being able reach something above 1 MHz with “electrides” of extraordinary quality (very high electron concentration, close to the limit). For the same reason, an application-dependent minimum frequency (plasma relaxation time, e.g. example) and the bearable penalty in the impedance of the dielectric layer (lower electron emission) and the maximum possible frequency depending on the quality of the “electride”. The most effective range is established between 50 KHz and 150 kHz (minimum instabilities) although it can be adjusted between 5 kHz and 200 kHz depending on the applications.

Cyclical relationship. In general, the active part of the pulse (negative part) will be as small as possible to perform its function: activation or maintenance of a plasma or conduction in a certain range of maximum and minimum values that represent a targeted effective current value, etc. The non-active (zero) part of the pulse will be the largest possible as to maintain the desired stable operation depending on the application, while minimizing energy consumption. The description of the applications details, in each case, the characteristics of the pulses. FIG. 14 illustrates the characteristics of the pulses.

Always negative pulses. Initially, with direct current DC polarization, it was observed that the material did not behave the same, polarizing the cathode to zero (ground) and the anode at +V_{c} (positive potential of V_{c} value) than polarizing the cathode negatively, −V_{c}, while the anode is at zero volts (ground). In the case of cathode at zero volts, which is common in almost all existing applications and patents, not only more instabilities are observed but the degradation process of the “electride” is accelerates considerably. This fact is due to a known effect in the field of microelectronics called “ground bounce” (FIG. 5 and Description of FIG. 5). When a group of electrons is emitted, the hole they leave in the cells of the material is not immediately filled by other electrons due to the low mobility of the electrons in the material, as described above. This fact creates a local zone with positive charge on the surface since thermionic emission of electrons is a basically superficial phenomenon. If there are O—, OH ions in the vicinity of the zone and the time it takes to reach the “electride” is less than that of the electrons in the material to fill the gap in the cells, then these ions will be incorporated into the “electride”, irreversibly rendering the affected cells unusable. Although there are very few oxidant ions, since the process is irreversible, the cathode will be unusable in a short period of time. Thus, the requirements established until now in various systems and patents incorporate partial pressures of possible oxidants that are truly unaffordable at the practical (<10-20 atm) [1] or surround the material with graphite or other reducing materials (various patents condition operation to this fact, such as US 2014/0354138A1). However, if the potential applied to the cathode is-V_{c}, even if there are areas of positive charge momentary on the surface of the “electride”, these will remain “sunk” in the potential negative of the “electride” as cathode (FIG. 6). It has been proven that even with the presence of oxidizing ions, the material is protected by being repelled by the negative potential of the cathode. Therefore, the pulses are negative and even a negative offset is established (FIG. 14C) for certain applications working with excess of oxidizing agents. This advantage will be one of the main claims given that the cathode allows operation with reactive elements such as Iodine (I on), which is one of the propellants with the highest potential in electric propulsion by being able to have a large mass in a small volume (in state solid-liquid) easily getting sublimated with the obvious advantages regarding storing gases, being, in addition, an element with a high atomic weight ideal for use as a gas at ionize in electric propulsion.

Problems of Polarization with Direct Current (DC)

Practically all cathodes made with “electride”, and other materials and all the patents found, polarize the cathode with direct current (DC). Not to be confused with pulsed plasma which refers to creating pulsed beams of electrons or plasmas with other objectives. This fact is due to historical reasons when assuming, almost definition of “polarization”, that the applied voltages are constant. The constant polarization (DC) of the “electride” as a cathode has the following problems:

1. In vacuum electron emission applications, the emission surface does not have an electrode for charge coupling (it is not metallized, because the emission itself would be blocked). Therefore, it will always have the Rₚ resistance as the emission limiter, aspect that the applicant has exhaustively verified with emission tests by temperature where it is difficult to reach 1 or 2 mA even at high temperatures, in contradiction with the fact of having a very low work function. The equation of Richardson-Dushman is fulfilled because an equivalent Am material constant results excessively low in these conditions by incorporating a low complete conductivity due to the high resistance of the dielectric layer on the surface. To solve this case, the present invention incorporates metal electrodes (25 in FIG. 13) very close to the “electride” (0.1 mm to 1 mm) using a dielectric spacer (24 in FIG. 13) or, even better, thin film electrodes deposited on dielectrics also constructed by thin film deposition using sputtering techniques, ALD, PLD, PVD, etc., that enable charge coupling with the “electride” using negative pulses between the cathode (“electride”) and the external auxiliary electrode (which will coincide with the so-called “keeper” in some cases and with the anode itself in others, having nothing to do with them for this function although it can also act as a “keeper” or anode. The thickness of the thin film dielectric will be tens to hundreds of nano meters while the metal that constitutes the auxiliary electrode may have a thickness of hundreds of nano meters and even greater than a micron. In this way, it increases between one and two orders of magnitude the electron current emitted with respect to the DC mode.

2. In the presence of gas (plasma) the gas ions can perform the function of external electrode (FIG. 10), favoring the extraction of electrons through the electric field created between said ions and the “electride” on their surface (described above as Schottky effect or Field Enhanced Thermionic Emission). This fact causes a current enhancement between one and two orders of magnitude compared to vacuum operation, being able to maintain the emission with relatively low temperatures (250° C.-300° C.) as cold cathode. However, the system is highly unstable, especially at low temperatures or when the system starts up. The solution of this problem is an important application of the present invention, detailing the nature of the problem and its solution below. However, there will also be a separate auxiliary electrode with a dielectric implemented either by thin sheets (spacers and metals) or by thin films of dielectric (tens or hundreds of nanometers) and metal (hundreds of nano meters and even something greater than a micron). (FIG. 13).

One of the most important problems that prevents the use of the C12A7:e-material “electride” in operating systems, as well as electron generators for neutralizers as for the hollow cathodes of the electric thrusters themselves, is their instability, production of large electrical discharges that deteriorate the material and the system and, finally, its passivation or disablement due to loss of properties on its surface. After years of research and experimentation, we have reached the root cause of said behavior or one of the main causes. FIG. 11 details the origin of the instabilities and uncontrolled discharges that occur in the cathodes manufactured with the material C12A7:e-“electride”. With conventional polarizations with direct current (DC) and in case of use in an environment with plasma (ions) continuous instabilities can be observed that cause strong and sudden discharges reaching tens of Amperes and even higher. And consequently, in addition to unstable and significantly uncontrollable operation, a strong degradation of the “electride” surface. This fact is due to the presence of fractures, dislocations, and defects on the surface, originating mainly during process of cutting and mechanizing the samples, which causes an extension in thickness of the layer dielectric. The thickness of the layer in the case of a perfect glass on its surface usually has few nano meters (less than 20 nm in general). In that case (22), the electrons are emitted by the tunnel effect, as occurs when metallizing the electrical contact surface of the cathode, allowing a homogeneous and controllable emission in direct current (DC). However, in areas where the width of the dielectric layer of the “electride” reaches several tens of nanometers, even hundreds of nanometers and even exceeds the micron (21), the tunnel effect has a low probability, very close to zero, so the current is zero. In this case, the excessive accumulation of charge makes the dielectric layer reach its breakdown potential and a sudden release of electrons. When this circumstance occurs, reaching the breakdown potential before tunnel driving, the result is a sudden emission of high current density electrons that do not corresponds to the capacity of the source used to power the cathode (nor in voltage nor in current capacity) since it originates from the accumulation of charge over time. The thicker the dielectric layer is at certain places, the more charge accumulates and the greater is the instantaneous discharge current density upon reaching the breakdown potential. There is an intermediate situation of charge accumulation reaching the tunnel effect before the rupture that manifests itself in an infinite number of micro current pulses superimposed on the continuous emission (DC). Large discharges, however, not only cause deterioration progressive damage to the surface of the cathode but can cause serious damage to the rest of the system (functioning as a neutralizer or as a cathode for ionic propellant) and in the own cathode power supply. To solve the problem (FIG. 12), force the charge coupling by using pulses as a way to polarize the cathode (pulse generator 17), which will force said coupling, improving the conductivity especially on the edges of said pulses where the high components are frequency for which a capacitance represents a low impedance and more specifically, on the 0 to −V_{c} edge, so that the discharge of the layer occurs dielectric practically independently of its thickness. The dependence of the conductivity of the dielectric layer using pulses is linear, equal to Cᵢ.w, while the dependence on the tunnel effect decreases exponentially with the thickness of the dielectric layer. In this way, with thicknesses greater than 100 nm there is practically no conductivity due to tunneling effect (DC polarization) while the conductivity of the same layer with pulses It has few variations with respect to the thinner layers. The pulses couple all the zones of the emission surface of the cathode in a forced manner, although they have different thicknesses of dielectric layer, avoiding charge accumulation and, therefore, current peaks, breakdown of the dielectric layer and progressive deterioration of the “electride” emission surface. Note that pulse charge coupling causes the conductivity of the dielectric in any case, obviously the better the less thickness said dielectric, but linearly, while the tunnel conductivity drops exponentially with the thickness of the dielectric layer, becoming very close to zero with thicknesses above 50 nm while the conductivity by pulse coupling is noticeable with those thicknesses and even with one or two orders of magnitude higher. That is, pulse coupling (pulse polarization) forces the charge to be evacuated, preventing its accumulation and, therefore, instabilities in the form of uncontrolled current peaks.

This implies the material impossibility for accumulating charge indefinitely, although the thickness of the dielectric layer is of the order of microns, and, therefore, the stability of the emission avoiding uncontrolled and random discharges that could deteriorate the surface of the “electride” and make the application in question unviable.

Some stability has been observed in DC by increasing the temperature to the maximum affordable values (800-950° C.), however, complete stability is not achieved, especially in hollow cathodes. The increase in temperature causes the decrease of the resistivity of the dielectric layer, so that the obtained current density increases and reduces the deterioration of the surface of the cathode made with the “electride” by reducing charge accumulations. This fact requires heating the cathode in advance and makes it impossible for the “electride” to be used as a cold cathode or as a device without a specific heater (heaterless cathodes). Practically all the patented systems with “electride” or other materials use an initial heater that can be turned off after a period, keeping the cathode hot from the bombardment of ions. The case of the so-called hollow cathodes. While they are feasible with other materials, such as LaB₆, although at very high temperatures (1200° C. onwards), no stabilization has been got with those made with the C12A7 “electride” material. The fact of passing the gas to be ionized inside a tube built with the “electride”, causes a great charge concentration in the “electride” right at the outlet, which is located in front of a electrode more positive than the cathode (keeper), which in turn causes a high concentration of emission current in the vicinity of the exit orifice, increasing the temperature, resulting in a decrease in the impedance of the layer dielectric, which increases the current at that point and, therefore, again the temperature. This positive feedback process even causes the melting of the “electride” in the exit orifice due to the uncontrolled increase in temperature, aggravated by the fact that the “electride” has an extraordinarily low thermal conductivity (of order of 1.2 W/m.K) that causes the existence of hot spots quickly due to the inability to evacuate heat. Added to the above, the ionization inside the tube is totally random depending on the area, given the impossibility of having a uniform distribution of the dielectric layer by the (physically aggressive) manufacturing and mechanization process of the hollow tube (normally through drilling). The results are, in addition to the melting of the exit zone of the hollow cathode, instabilities with current peaks truly amazing (even registering hundreds of Amperes), temperature totally uncontrollable with an inhomogeneous distribution in the hollow cathode and the irreversible deterioration of said hollow cathode in a few hours.

Note that the destruction or highly unstable operation of any hollow cathode built with the “electride” occurs even with negative supply (−V_{c}), when operating continuous mode. In this case, you are only preventing oxidation but not the instabilities due to random discharges and uncontrolled overheating.

As in the case of high vacuum, the arrangement of auxiliary electrodes (25) on a controlled dielectric (24) allows for more effective control of charge coupling using pulses so it will be used in both cases, high vacuum and in contact with ions (plasma). Two techniques will be used to arrange these electrodes:

Dielectric and metal electrodes using thin sheets, between 0.1 mm and 1 mm depending on the type of applications. Alumina can be used as dielectrics (better because it has a coefficient of thermal expansion comparable to “electride” reducing material fatigue and possible fractures), MgO, BN for high temperatures (range from 800° C. to 950° C.). For low temperatures it is possible to use mica and SiO₂, which is an excellent dielectric but with a thermal expansion coefficient very different from “electride” (0.5 versus 6.10⁻⁶ K⁻¹). As for the metals, for high temperatures Mo (Molybdenum), Tantalum (Ta), and Wolfram (W) are especially indicated. Titanium (Ti) is an excellent option if you do not work in high vacuum and high temperatures. Platinum (Pt) and Palladium (Pd) are indicated for certain applications where a complementarity of the work functions, that is, they are the highest possible, as is the case of Pt and Pd. In general, metals should be paramagnetic, with very low magnetic susceptibility since pulses are being used (high components frequency). Therefore Fe, Co, Ni are not indicated as ferromagnetic materials, nor its alloys, since there would be large losses in said electrode by the high frequency components of the pulses.

Dielectric and metallic electrodes deposited as thin layers on the “electride”. In this case, the dielectric could have a thickness of tens of nanometers to hundreds of nano meters. It has been found that the ideal is hafnium oxide (HfO₂) for the following reasons: it has practically the same coefficient of thermal expansion than the “electride” (6.10⁻⁶ K⁻¹) being the closest of the oxides known and has one of the highest dielectric constants (electrical permittivity εr between 15 and 25) of the known simple oxides and is thermally stable up to high temperatures (1000° C.). Alumina (Al₂O₃) can be used with poorer results and SiO₂ only at low temperatures. For deposition in thin film reactive sputtering techniques, ALD, PLD or similar are used. Regarding the metals, Mo (molybdenum) is the more suitable in the first instance, with great temperature stability and good adherence like Hf (hafnium) itself due to the suitability of its thermal expansion coefficient for high temperatures. Likewise, titanium (Ti) and chromium (Cr), with excellent adherence, although with limitations at high temperatures and high vacuum due to its degree of evaporation. Platinum (Pt) and palladium (Pd) will be used in special cases, where complementarity of the functions of work, that is, they are the highest possible, as is the case of Pt and Pd.

With the use of the pulsed polarization regime and the auxiliary electrodes for the charge coupling an additional advantage has been found: the possibility of producing the heating of the cathode through the pulsed regime itself by coupling with the auxiliary electrode. This fact allows not to require any heater at any moment, being fully heaterless. The current ones have a heater that is disconnects when the operating temperature is reached, being maintained by the bombardment of ions in the material. In the present invention it is not necessary at any time, being the polarization system and coupling with the auxiliary electrode enough for this purpose.

The temperature can be adjusted accurately since the Joule effect is produced by the “electride” specifically (good and homogeneous conductivity) so the power is proportional to Rᵢ*|²_{eff}, Rᵢ being the intrinsic resistance of the “electride” used (without the effect of dielectric layer on its surface) and I_{eff} the effective current achieved through the pulses.

The invention, therefore, allows constructing cathodes without a heater itself (“heaterless”) but also allows operation at low temperatures, even in high vacuum. In fact, it operates perfectly at temperatures between 200° C. and 350° C., both in high vacuum as in the presence of ions. This fact is due to the field emission effect (Field Enhanced Thermionic Emission) or Schottky effect, as detailed above. This effect causes a decrease in the effective work function if electric fields greater than 105 V/m are applied to the surface of the “electride”. Since the potential of auxiliary electrode is located less than a micron from the surface of the “electride”, the system enters directly into the Schottky region, producing “cold” emission. This allows the creation of cold cathodes, which are very useful in many applications and with considerable energy savings. In fact, it is possible to get plasmas with less than 1 W of power at the cathode and with really low potentials (less than 50 V, and even less than 20 V).

In summary, the invention solves the main problems of energy-emitting cathodes. electrons made with the material C12A7:e-“electride”:

High emission current densities by not having a high impedance due to the dielectric layer on the surface of the “electride” that it always has naturally.

Stability and absence of uncontrolled discharges.

Stability of hollow cathodes in any environment

Degradation is avoided even in oxidizing atmospheres and even reactive elements like Iodine (I⁻)

Possibility of heating with the cathode's own polarization signal.

Possibility of combining both pulse mode and DC mode.

Possibility of making cold cathodes (cold cathodes) with high current density emitted at low temperatures.

Possibility of varying the engineering of the cathode: disc-shaped cathodes, hollow disc and conventional hollow cathode

Applications of the invention.

Electron generating cathodes for space applications.

They are considered the main core of the neutralizers of the ionic thrusters and the electron-generating cathode of the ionic thrusters themselves when the plasma generation is based on the ionization caused by a beam of electrons colliding with the used gas (typically a noble gas). At turn, they can operate the high vacuum (“dry” neutralizers only) providing a beam of electrons in vacuum or through the generation of ions (gas neutralizers, hollow cathodes and the cathode of the ion propellant) when it is based on causing ionization by the collision of a beam of electrons with the gas used.

In the case of use in vacuum (FIG. 15), as explained above (not existence of an external electrode that can be implemented by the ions themselves), the constant bias or DC emission can only occur at high temperatures (e.g., above 650° C.) and this is very little relevant (few mA) due to the resistance of the dielectric layer. On the other hand, with pulsed polarization and adding a metal electrode (Mo in the first instance, Hf in the second and Pt, Pd, Ni, Ta in special applications) deposited as a thin film on an intermediate dielectric controlled in thickness, the emission increases by one or two orders of magnitude. The dielectrics must be compatible in terms of coefficient of thermal expansion with the “electride”, which has a value close to 6 (10⁻⁶ K⁻¹) and, on the other hand, they must have the highest breaking potential possible so that they can be made as thin as possible (greater capacity and, therefore, lower losses with pulses) avoiding breakdown in the entire voltage range of operation and considering possible charge accumulations. Due to the above, hafnium (HfO₂) is fixed as the first option as it has a thermal expansion coefficient practically coincident in the temperature range of 250° C. to 900° C. and a potential of rupture greater than 500 KV/mm and the alumina itself (Al₂O₃) (with a coefficient between 7 and 8) as the most suitable.

### Cathode Based on the Hollow Disk Configuration.

FIG. 16 details a complete system based on an architecture also novel thing that we call “hollow disk”. Normally the hollow cathode has a tubular shape (hollow cylinder) with a diameter smaller than its length, producing emission (and ionization of the gas used) along the inside of the tube and especially in the vicinity of the exit hole (32). In the case of hollow cathodes conventional tests carried out with the “electride”, the concentration at the exit orifice is maximum. Since charge coupling is used in the present invention in the emission surface, the larger the surface right at the exit the better the coupling. By extending the outer surface of the hollow cylinder we reach the “hollow disc”, much more effective, stable and controllable than the conventional hollow cylinder. The disk, containing the separators (24) and the metal electrodes (25) (keeper) or better and more integrated and effective, with an oxide layer (annulus) and the metal electrode itself deposited by sputtering, incorporates all the essential elements by itself. On the back face (contact) a metal (4) has been deposited (ideally Mo) and the assembly is preferably assembled with insulating materials (31) that prevent losses, unwanted discharges, and areas of uncontrolled plasma. The gas is introduced through the center (33) and the contacts are moved to the back where it is very convenient to use RF connectors (type BNC, F, N, UHF or similar depending on the pulse width so that they withstand the maximum applied voltages). It is possible to use the tube itself gas (33) (typically “1/4” or “1/8” inch stainless steel), insulated with alumina, as the “keeper” coupling electrode itself. It is a simple, reliable solution that can be used in many applications.

Cathode based on the “hollow cathode” configuration.

FIG. 17 details the design of a conventional hollow cathode in hollow cylinder shape. It should be noted that until the moment of the presentation of this invention, no hollow cathode made with C12A7:e-“electride” has been presented that works stably beyond a few hours. This fact is due to the problems noted above while the hollow cathode inserted into the device that is the object of the present invention and polarized in the way that has been detailed, not only works stably but also significantly increases the emitted current density with respect to current devices, in addition to achieving a significant improvement in the relationship between the current emitted and the current collected at the anode with respect to the one injected by the power supply to the cathode, which reaches 99%, both in DC and with pulses, once achieved the desired regime from cold with the pulses themselves. There is no known device that has this feature. FIG. 17.A represents the hollow cathode without the outer casing, with the metallization (4) on both the cylinder walls (optional but recommended) and on the back, that is, on the entire surface except the face of emission and the inside of the cylinder. FIG. 17.B shows the hollow cathode with the casing insulator, and 17.C shows a cut perpendicular to the bases of the cylinder (longitudinal) where appreciates the “electride” (1) with its natural dielectric layers (2), the metallization of the walls and the lower base (4), the gas outlet hole (32) as well as its inlet (31), the dielectric (24) made either as a spacer (between 0.1 and 1 mm) or as a deposition of thin oxide film (generally HfO₂) of tens or hundreds of nanometers and the metallization for charge coupling (25) that can be carried out with a metal crown on top of the spacer or by thin film deposition of hundreds of nano meters on top of the rust. The most suitable metals are Mo first and second choice Pt, Pd, Ta, W and even graphite. Ferromagnetic metals are not recommended due to the large losses expected when exposed to pulsed polarization (e.g. example Ni, Fe, Co).

Electron-generating cathodes as general-purpose “electron guns.”

The invention is applicable to any general-purpose electron emitter with the configurations described above, both in high vacuum or with gas (plasma), with high temperatures or cold cathodes.

Electrolysis of water (Hydrolyzers).

It responds to the same principle as the previous applications: interaction of the cathode with ions, in this case in a liquid medium (instead of gaseous as in the case of plasma) although the possibility of hydrolysis of water in the vapor phase generating plasma. FIG. 18 details two liquid water (18.A) and water vapor electrolyzers (18.B).

As a cathode for electrolysis, and more specifically for water, the cathode made with the C12A7 “electride” material and polarized with (negative) pulses is especially efficient. The reason is the reduction of the so-called “electrode potential” because the coupling of any electrode (specifically the cathode, although it also happens with the anode) with ions in a liquid medium (as occurs with ions in a medium gaseous, that is, plasma) requires the exchange of electrons (from cathode to ion) and, therefore it depends on its work function. As described above, the material C12A7 “electride” has one of the lowest work functions of stable materials (2.4 eV) and, in addition, the coupling with pulses object of the present patent is especially indicated to minimize the dielectric effect of the surface of the material and the dielectric itself of the aqueous solution with the ions. In addition, in case of pure water, it is possible to produce the coupling using anode electrodes very close or extremely close (with the anode electrode equivalent to the “keeper” with integrated plasma) (FIG. 18.A). Since pure water is a polar substance, with a permittivity very high relative electricity (around 80), the coupling of the cathode with a pulsed regime instead of DC allows for very high conductivity. Since C12A7 “electride” has the lowest known work function for stable materials, the electrode potential is the lowest possible, so the efficiency of electrolysis will be maximum. An important aspect in this application is the effect of water on the stability of “electride”. Indeed, even without polarization, the “electride” can decompose the water, generating H₂ and capturing OH⁻ and O^{═} ions. The problem is the degradation of “electride” in this case, as the cells are left without electrons and with stable ions. Even with negative forced polarization (with pulses and with DC), some degradation of the “electride” over time will happen. To avoid it, without hardly reducing efficiency, two methods are proposed:

To deposit a thin layer of protective oxide, which also serves as a support for the deposition of the anode as a thin film, which allows the coupling of the pulses. As in the case of plasma, HfO₂ is the first option (given its high dielectric constant), in this case, given that the temperature is very low (less than 90° C. with liquid water and, normally, less than 350° C. with water vapor), SiO₂ is also very convenient due to its stability in water, as well as MgO, Al₂O₃ and any oxide that is a good dielectric (high dielectric constant) and water resistant.

The membranes (34), in this case, must allow hydrogen gas and any type of ion to cross, having as its sole function the retention of the water molecules, avoiding the need to use PEM (Proton Exchange Membrane) type membranes. Typical membranes for this function are thin PTFE membranes (0.1 to 1 mm). The cathode made with the material C12A7:e-“electride”, as well as the arrangement of elements and the concepts introduced in the present invention make charge separation possible given that the emission of electrons occurs only in one direction (from the cathode to the anode). That is to say, the configuration is similar to diodes based on thermionic emission tubes. Thus, the membrane does not have to distinguish the charge, positive or negative, but the molecules, not allowing liquid water (38) or vapor phase (46) to pass into the gas diffusion zone (37). This phenomenon has not been found implemented in any device so far and represents a fundamental advantage over one of the most critical elements for electrolyzers based on PEM membrane, which is precisely said membrane. On the other hand, water can be pure since a charge coupling occurs between cathode and anode, and not a continuous conduction. Water has a relative dielectric constant very high (εr around 80) which makes it precisely an ideal dielectric with very low losses at high frequencies (pulse edges). In the case of pure water liquid (FIG. 18.A) and in a gaseous state (FIG. 18.B), only the pulses should be used (17). The anode (10) can be made of the usual high work function materials (Pt, Pd, Ir, Ti+IrO₂, etc.). The H⁺ ions are neutralized by the cathode whose emission is favored precisely by these ions (protons) as they are the smallest ions, thus achieving a maximum approach to the active zone of the “electride”, even being adsorbed by the dielectric layer, a fact that favors emission by electric field (Schottky) and which has been repeatedly tested in the laboratory. In touch with the cathode there is a gas diffusion membrane, normally made of graphite and very porous polymers, to allow the diffusion of H₂ and its exit through the corresponding tube (36). Oxygen ions (or more specifically OH ions), due to the features of the invention that have been repeatedly detailed, do not cross the membrane (34) since they encounter a potential barrier on the surface of the “electride”, recombining at the anode as molecular oxygen (O₂) that is collected at through the tube (35). To do this, the anode must facilitate oxidation, capturing electrons. This function is appropriate for elements and compounds complementary to the “electride”, such as Pt, Pd, Ir, IrO₂, etc., characterized, precisely, because of its high work function. Both pulsed and DC cathode polarization, as well as that of the anode (29) (not strictly necessary since it can be zero volts) can be adjusted both in amplitude (Vₚᵤₗₛₑₛ and V_{c}), “offset”, as well as the density of current through R_{c} (28) and Rₐ (30) resulting in electrolysis, and therefore production of H₂, completely on demand and very controllable. The pulse regimen can, as has been seen, heat the cathode and significantly increase the performance of the electrolyzer, added to the fact of the low “electrode overpotential” at the cathode as it is built with the material C12A7:e-“electride” due to its low work function. The set is collected in an airtight container (31). Layout in the form of a “stack” is possible to build electrolyzers, stacking cathodes-membrane-anodes precisely because of the best architecture of the present invention: depositing thin layers or films of oxide on the cathode that implement the dielectric and thin layers of metal for the electrodes themselves (anode in this application). In this case, the water retention membrane that allow any ion to pass is physically necessary, and the anode can be made through the deposition of a thin film of the materials suitable for said anode, which, as indicated, must have a high work function: Pt, Pd, Ti+IrO₂, etc.).

By extension of the electrolysis of water itself, the present invention is applicable to the process-based water purification, disinfection, and treatment systems electrochemical, using the C12A7 “electride” material as a cathode and more specifically, with a pulse regimen. In this case it would be especially appropriate to use an integrated anode built by deposition of the corresponding material (Pt, IrO₂, Ti, TiO₂, etc.) on a dielectric deposited as a thin film (ideally HfO₂ and also SiO₂, MgO, Al₂O₃ and any water-resistant oxide), since it is not necessary to separate gases. This method, with dielectric thicknesses of tens, hundreds of nano meters, would have very low losses due to the high capacity of the anode-cathode junction, ideal for the use of pulses.

### REFERENCES

[1] S. Kim and H. Hosono. Philosophical Magazine. Vol 32. N 19-21. 2596-2628. (2012).
[2] Y. Toda, Y. Kubota, M. Hirano, H. Hirayama and H Hosono. ACS nano Vol 5. N 3. 1907-1914. (2011).
[3] P V Ong, H Hosono, and P V. Sushko J. Phys. Chem. C 123 6030 (2019).
[4] J Fabian-Plaza, G Meiro, A Post, R Pérez-Casero, F J Palomares, P Tejedor, S Naghdi, A Várez, and G Sánchez-Arriaga Acta Astronaut. 177 806 (2020).
[5] M. Goebel and I. Katz. Fundamentals of electric propulsion: Ion and Hall Thrusters. JPL-NASA (2008).

1. A cathode based on a C12A7: e “electride” material for thermionic emission of electrons comprising:
a cathode obtained from the C12A7:e-“electride” material with polarization in pulsed regime, with negative voltage with respect to ground or zero potential reference or referred to an anode in case of floating potential, having foreseen that an emission current is increased by charge coupling with an additional electrode (“keeper” or in some cases anode) specially arranged for through an additional homogeneous dielectric that defines a medium that avoids direct contact with the “electride” at a very short distance (tens or hundreds of nano meters in the case of integrated manufacturing and tenths of a millimeter when using physical separators) and, the coupling constants being fixed independently of a thickness of natural and unavoidable dielectric layer at “electride” surface.

2. The cathode according to claim 1, wherein the dielectric layer at the surface of the “electride” has a heterogeneous thickness, to which an auxiliary electrode is attached (“keeper” or anode depending on the case) and a pulsed regime between the cathode and said electrode.

3. A procedure for a thermionic emission of electrons from the cathode of claim 1, wherein the cathode is subjected to a phase of heating through a train of pulses between the cathode and the auxiliary electrode (“keeper” or anode) as a stabilizing medium at startup as a cold cathode and even working directly as a cold cathode at temperatures between 150° C. and 250° C. in a stable manner maintaining the corresponding pulse regime, so that said heating is produced by the Joule effect of the coupling between the “electride” and the auxiliary electrode; having foreseen that in cases of use of plasma, the heating is combined due to the Joule effect of the cathode-keeper coupling with the bombardment of the plasma itself.

4. The cathode according to claim 1, the dielectric (24) added between the surface of the “electride” and the auxiliary metal electrode (25) is a thin layer (tens or hundreds of nano meters) of hafnium oxide (HfO₂) deposited by reactive sputtering or ALD (Atomic Layer Deposition) or PLD (Pulsed Laser Deposition) or any other technique that allows depositing thin layers (nano metric) of hafnium oxide homogeneously (without gaps that cause short circuits) and maintaining its dielectric properties, having foreseen that optionally and for operation at low temperatures, said dielectric (24) can be also made of SiO₂, MgO, Al₂O₃, BN, etc.

5. The procedure, according to claim 3, wherein the auxiliary electrode (25) (“keeper” or anode depending on the case) is made by deposition of thin layers of metal (25) (tens or hundreds of nano meters thick) on the previous dielectric (24) by cathodic sputtering or evaporation or other applicable techniques.

6. The procedure according to claim 3, wherein the auxiliary electrode (25) (“keeper” or anode depending on the case) is made by using thin sheets (between 0.1 and 1 mm) of metal supported on dielectric spacers.

7. The procedure according to claim 3, wherein the metallization of the surface of contact of the cathode (4) (rear face in case of hollow or compact disc shape or rear face and outer walls in the case of a hollow cylinder), His made with molybdenum (Mo) deposited as a thin film (hundreds of nano meters) via cathodic sputtering (sputtering) and other techniques for this case, so that massive tunnels are produced between said metallization and the inside of the “electride” saving the dielectric layer; having foreseen that for special cases in which the cathode works at low temperatures, metallization is carried out with Ti, Pt, Pd, W, Ta and Cr and other metals that are diamagnetic or paramagnetic with very low magnetic susceptibility.

8. The Procedure according to claim 3, wherein the metallization of the auxiliary electrode (25) is made with platinum (Pt), palladium (Pd), in cases where a big difference in work functions between said electrode and the cathode is required (for example electrolyzers and fuel cells) as well as Ir, IrO₂, Ti+IrO₂, Ti+RuO₂, while the molybdenum (Mo) and titanium (Ti) for intermediate cases in terms of work function of the anode and hafnium (Hf) and tantalum (Ta) with the lowest possible work function in said electrode, deposited as a thin film (hundreds of nano meters) with cathodic sputtering (sputtering) and other techniques for this case, or sheets are used from 0.1 to 1 mm thick of said metals in the case of using fine physical dielectrics separators instead of thin films; having foreseen that for special cases in those that work at low temperatures, the metallization is carried out with W, Ta and Cr and other metals that are preferably diamagnetic or paramagnetic with very low magnetic susceptibility.

9. A procedure for the thermionic emission of electrons from the cathode of claim 1, wherein the cathode is used as generators of free electrons in high vacuum (thermionic electron beam emission) in a regime of high temperature between 800° C. and 950°, heating through the pulsed regime between the cathode and the auxiliary electrode (“keeper”) (without heater or “heaterless”).

10. The procedure for the thermionic emission of electrons from the cathode of claim 1, wherein the cathodes are used as generators of free electrons in high vacuum (electron beam emission) over a range of temperatures between 200° C. and 350° C., causing thermionic emission due to the Schottky effect rather than by temperature (without heater or “heaterless”) thanks to the cathode coupling with the auxiliary electrode (25) and the pulsed regime used for polarization.

11. The procedure for the thermionic emission of electrons from the cathode of claim 1, wherein the cathodes are used as generators of free electrons in a medium with plasma or to generate said plasma through the injection of a noble gas (He, Ne, Ar, Kp, Xe) or with hydrogen and other gases (N₂, Iodine and sublimated metals), in which the configuration of said cathodes may be disk, between 4 and 50.8 mm in diameter and 1 to 2 mm thick, hollow disc equal to the previous one but with gas entry right in the center of the disc or hollow cylinder (current “hollow cathode”).

12. The procedure for the thermionic emission of electrons from the cathode of claim 1, wherein the cathode is used in high vacuum for the manufacturing of neutralizers of ion beams used in aerospace electric thrusters, and electron guns in general working in high vacuum (microscopy, “electron etching”, etc.).

13. The procedure for the thermionic emission of electrons from the cathode of claim 1, wherein the cathode is used in high vacuum for the generation of plasma at very low energies through the ionization of gases by bombardment of electrons generated by the previous cathode, independently of the relative pressure of one (cathode that can be in high vacuum) and another (gases to ionize).

14. The procedure for the thermionic emission of electrons from the cathode of claim 1, wherein the cathode is used in an ionized gas (plasma) environment or that generate plasma in their environment, both at high temperature as cold cathodes at less than 250° C. with start-up at room temperature and even smaller, which are used as neutralizers of ion beams in aerospace electric propulsion, based on compact discs, hollow discs or hollow cylinders (“hollow cathodes”) to which part of the gas to be ionized is passed to improve the emission and whether or not the union of the plasma of the neutralizer with the plasma to be neutralized occurs (“plasma bridge”).

15. The Procedure for the thermionic emission of electrons from the cathode of the claim 1, wherein the cathode is used in an ionized gas (plasma) environment or that generate plasma in their environment, both at high temperature as cold cathodes at less than 250° C. with start-up at room temperature and even smaller, which are used as electron generating cathodes in the ionic thrusters basically as a plasma generation mechanism and based preferably in hollow discs and hollow cylinders (“hollow cathodes”) to which makes the gas pass to be ionized.

16. The procedure for the thermionic emission of electrons from the cathode of the claim 1, wherein the cathode is used in an environment of ionized gas (plasma) that are used for the generation of plasma itself with very low energies (achieved with less than 1 W of power) through the ionization of gases by bombardment of electrons generated by the cathode.

17. The procedure for the thermionic emission of electrons from the cathode of claim 1, wherein the cathode is used in an ionized gas (plasma) environment for the very generation of plasma necessary in aerospace electric propulsion, using negative ions (such as iodine, I⁻ or other used in propulsion through ions obtained from the sublimation of certain elements of high atomic weight or from the hydrolysis of water or other ionic compounds, such as oxygen).

18. The procedure for thermionic emission of electrons from the cathode of claim 1, wherein the cathode is used in an ionized gas (plasma) environment for the generation of the said plasma itself with very low energies, for material treatment (plasma “etching”), and for ion bombardment systems or ion guns in general.

19. The procedure for the thermionic emission of electrons from the cathode of claim 1, wherein the cathode is used in an ionized gas (plasma) environment for the generation of said plasma with very low energies to cause the dissociation of compounds in gaseous state (such as ammonia, NH₃) through the ionization of its constituent elements (H and N in this case) or synthesis of certain compounds, generally in gaseous state, (such as ammonia, NH₃) from the ionization of its constituent elements; having foreseen that the anode (10) is made of Pt, Pd, Mo, Ir, Ru, Ti, Ti+IrO₂ or Ti+RuO₂.

20. The Procedure for the thermionic emission of electrons from the cathode of claim 1, wherein the cathode is used for the manufacturing of electrolyzers (water electrolysis) where water molecules are in a liquid phase, where water (38) has electrolytes added (typically KOH) and a simple separation membrane is used molecular separation of water from the hydrogen gas (such as thin PFTE membranes and other polymers), where both the negative pulsed polarization (17) and the negative constant (16); having foreseen that the anode (10) is made in Pt, Pd, Mo, Ir, Ru, Ti, Ti+IrO₂ or Ti+RuO₂.

21. The procedure for the thermionic emission of electrons from the cathode of claim 1, wherein the cathode is used for the manufacturing of electrolyzers (water electrolysis), where the water molecules (38) are pure and are in a liquid phase and a simple molecular separation membrane of water with respect to hydrogen gas (as thin membranes (PFTE and other polymers) is used; having foreseen that a mode negative polarization pulse (17) will be applied, forcing the ionization of water in the liquid phase without generating plasma (although it may be generated) by separating the ions constituents of hydrogen and oxygen.

22. The procedure for the thermionic emission of electrons from the cathode of claim 1, wherein the cathode is used for the manufacturing of electrolyzers (water electrolysis) where the water (46) is pure and is in a gas phase (water vapor) obtained in this way combining pressure and temperature conditions for minimal condensation, in where a simple membrane is used for molecular separation of water from gas hydrogen (such as thin PFTE membranes and other polymers), with the anode (10), made of Pt, Pd, Mo, Ir, Ru, Ti, Ti+IrO₂ or Ti+RuO₂, applying a pulsed mode negative polarization (17) and forcing the production of ions in a gaseous state, reaching or not to the plasma form (convenient).
